(19) United States
(12) Patent Application Publication
(10) Pub. No.: US 2026/0310875 A1
(43) Pub. Date: Oct. 8, 2026

(54) REDUCING POWER CONSUMPTION IN A LOGIC CIRCUIT AND RELATED METHODS

(71) Applicant: MICROSOFT TECHNOLOGY LICENSING, LLC, Redmond, WA (US)

(72) Inventors: Harikrishnan KUMARAPILLAI CHANDRIKAKUTTY, Santa Clara, CA (US); Michael G. LOVE, Union City, CA (US); Nicolas MELLIS, Mountain View, CA (US)

(21) Appl. No.: 19/253,572

(22) Filed: Jun. 27, 2025

Related U.S. Application Data
(63) Continuation-in-part of application No. 19/172,605, filed on Apr. 7, 2025.

(51) Int. Cl. G06F 30/398; G06F 30/27

(52) U.S. Cl. CPC G06F 30/398; G06F 30/27

(57) ABSTRACT

The disclosed techniques provide a method for reducing power consumption in a logic circuit. A design of the logic circuit is provided. The logic circuit includes storage circuits that store state information and receive clock signals. Toggle activity data indicating whether the stored state information changes in response to a respective clock signal is determined. A graph that represents the toggle activity data is constructed. The graph includes nodes and edges. The nodes correspond to the storage circuits. The edges represent statistical relationships among the determined changes in the stored state information. A graph neural network to the graph is applied. The application includes generating an embedding that characterizes patterns in the toggle activity data. Via a reinforcement learning agent, control logic that selectively gates the clock signals provided to storage circuits for which the stored state information is predicted, based on the embedding, to remain unchanged is determined.

### CROSS-REFERENCE TO RELATED APPLICATIONS

This application is a continuation-in-part of U.S. patent application Ser. No. 19/172,605, docket number 503556-US01, filed on Apr. 7, 2025, titled “REDUCING POWER CONSUMPTION IN A LOGIC CIRCUIT AND RELATED METHODS,” which is hereby incorporated by reference in its entirety.

### FIELD OF THE DISCLOSURE

The technology of the disclosure relates, in general, to reducing power consumption in an integrated circuit (IC), and more particularly to automating the design a low-power IC.

### BACKGROUND

Integrated circuits (ICs) are ubiquitous in electronic devices and can be a significant consumer of the power provided to an electronic device. Reducing power consumption in such devices is an objective of manufacturers of ICs, for energy conservation and, in particular, to increase the battery life of hand-held and other battery-powered devices. ICs include semiconductor chips on which transistor circuits are formed. Transistor circuits include sequential logic circuits (e.g., storage circuits) that are able to retain one of two electrical states during the period of a periodic clock signal. Other inputs to the storage circuit determine whether or not the storage circuit actually changes state at the start of a new clock signal period. Switching storage circuits from one state to another can cause electrical nodes in the circuits to be charged and/or discharged, which consumes power. Power may also be consumed in a storage circuit in every cycle of the clock signal even when there is no change of state. As semiconductor chips become more complex and higher performance is demanded, the clock signal frequency increases, further increasing the rate of power consumption.

Even though semiconductor chips in electronic devices are in packages that may have excellent heat dissipation characteristics, the packaging alone may not be enough to handle the problem of excessive heating. This issue may also be addressed in the design and manufacture of the semiconductor chips, by imposing power limits to keep their heat generation lower. Chip designs are subject to power limits that are more and more difficult to achieve as performance requirements increase (e.g., clock frequencies increase). One technique that designers use to reduce power consumption in silicon chips is to include clock gating logic which will gate (i.e., selectively couple) the clock signal provided to a storage circuit depending on whether other input signals provided to the storage circuit indicate that the state of the storage circuit will not change in response to the clock in a particular clock cycle. The clock gating logic may be inserted into a circuit design after a logic design is synthesized into an actual circuit design. When synthesis is completed, power analysis tools may determine that the circuit design exceeds power consumption limits. A designer addresses this by manually figuring out the condition in which a storage circuit will switch states and adding specific clock gating logic to block the clock signal from the storage circuit unless this condition arises. However, there are drawbacks to this method that include increased circuit area and power consumption due to the addition of the clock gating logic, as well as timing problems due to clock gating logic inserted into the clock signal path.

### SUMMARY

Exemplary aspects disclosed herein include reducing power consumption in a logic circuit. Non-transitory computer readable storage medium storing instructions to reduce power consumption in a logic circuit is also disclosed. Reducing power consumption in a logic circuit design may include inserting clock gate circuits into the logic circuit design to selectively couple clock signals that are provided to sequential logic circuits (e.g., storage circuits). A storage circuit may be triggered (e.g., edge triggered or level triggered) by a clock signal and may consume power every time it is triggered by a clock signal. Clock gating is added to block the clock signal from triggering a storage circuit in conditions in which the storage circuit would not change state in response to being triggered by the clock signal.

An exemplary method of inserting clock gate circuits in a logic circuit design includes grouping (e.g., identifying groups of) storage circuits in the logic circuit design into a first plurality of groups and also grouping the storage circuits into a second plurality of groups, where the second plurality of groups has fewer groups than the first plurality of groups. The method includes inserting clock gate circuits into the logic circuit design based on the first plurality of groups to generate a first updated circuit design and based on the second plurality of groups to generate a second updated circuit design. The method also includes selecting one of the first updated circuit design and the second updated circuit design based on a comparison of test results of the first updated circuit design and the second updated circuit design. In some examples, the storage circuits may be grouped into the first plurality of groups based on storage circuits that toggle in a sequence of consecutive clock signal cycles. A logic circuit design may be selected from among multiple updated circuit designs in which storage circuits are clock gated in different groups to provide optimal power consumption.

In one exemplary aspect, a method of reducing power consumption in a logic circuit is disclosed. The method comprises: grouping storage circuits of a logic circuit design into a first plurality of groups, and inserting first clock gate circuits into the logic circuit design to generate a first updated circuit design, wherein each first clock gate circuit is configured to selectively couple a clock signal to the storage circuits in a corresponding group of the first plurality of groups. The method also includes grouping the storage circuits into a second plurality of groups, wherein the second plurality of groups comprises fewer groups than the first plurality of groups, and inserting second clock gate circuits into the logic circuit design to generate a second updated circuit design, wherein each second clock gate circuit is configured to selectively couple the clock signal to the storage circuits in a corresponding group of the second plurality of groups. The method further includes selecting one of the first updated circuit design and the second updated circuit design as a selected design based on a comparison of a first result of a first test executed on the first updated circuit design and a second result of the first test executed on the second updated circuit design.

In another exemplary aspect, a non-transitory computer-readable storage medium is disclosed. The non-transitory computer readable storage medium includes instructions which, when executed by a processor, are configured to control the processor to: group storage circuits of a logic circuit design into a first plurality of groups, and insert first clock gate circuits into the logic circuit design to generate a first updated circuit design, wherein each first clock gate circuit is configured to selectively couple a clock signal to the storage circuits in a corresponding group of the first plurality of groups. The instructions are also configured to control the processor to group the storage circuits into a second plurality of groups, wherein the second plurality of groups comprises fewer groups than the first plurality of groups, and insert second clock gate circuits into the logic circuit design to generate a second updated circuit design, wherein each second clock gate circuit is configured to selectively couple the clock signal to the storage circuits in a corresponding group of the second plurality of groups. The instructions are further configured to control the processor to select one of the first updated circuit design and the second updated circuit design as a selected design based on a comparison of a first result of a first test executed on the first updated circuit design and a second result of the first test executed on the second updated circuit design.

In addition to the techniques described above, the present disclosure introduces a new machine-learning-driven method for clock gating in logic circuit designs. The method improves upon traditional strategies by using simulation data to identify patterns in register activity and to automatically generate tailored clock gate control logic. The method begins by simulating a design of a logic circuit and identifying each instance in which a storage circuit within that logic circuit (e.g., a register) changes value. These identified changes, which reflect switching behavior of the storage circuits over time, are referred to as toggle activity data. The toggle activity data provides the foundational input for the machine learning models used in the later stages of the method.

To extract useful patterns from the toggle activity data, the method constructs a graph in which each storage circuit appears as a node. The method adds connections between nodes to highlight statistical patterns in switching behavior, such as circuits that tend to activate together or in consistent sequences, that are relevant to decisions about how to group storage circuits for shared clock gating. A graph neural network processes this graph and produces a numerical representation that captures behavior patterns across the logic circuit design.

The numerical representation generated by the graph neural network is provided as input to a reinforcement learning model that has been trained to identify effective clock gating strategies. The trained model evaluates the representation to generate a predicted grouping matrix that defines how storage circuits should be organized into clock-gated groups. The grouping decisions made by the reinforcement learning model are informed by prior training on examples of logic circuits and associated performance metrics, enabling the model to generalize its clock-gating strategy to new circuit designs.

The method uses the predicted grouping matrix to generate clock gate control logic by synthesizing a finite state machine for each group of storage circuits. Each finite state machine determines whether its corresponding group is likely to change state during an upcoming clock cycle and disables the clock signal to that group when no change is expected. The method inserts the finite state machines and clock gate circuits into the logic circuit design to produce a completed, power-optimized version of the logic circuit that reflects the clock-gating strategy inferred by the trained reinforcement learning model.

The use of machine-learning models that are trained on realistic circuit behavior enables the described method to be applied across a wide range of different logic circuit designs without requiring manual retuning or adjustment. The method's applicability to different logic circuit designs enables repeated use of the same clock gating generation process in multiple design contexts, resulting in improved power efficiency and reduced engineering workload during development of digital systems.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is a schematic representation of a logic circuit design including combinational and sequential logic circuits (e.g., storage circuits) without clock gate circuits to selectively couple clock signals to the storage circuits;

FIG. 2 is a schematic representation of the combinational logic circuits and storage circuits in the logic circuit design of FIG. 1 including individual clock gate circuits for each storage circuit to selectively couple clock signals to reduce power consumption;

FIG. 3 is a timing diagram illustrating activity in the storage circuits in the logic circuit design in FIG. 1 through multiple cycles of a clock signal provided to the storage circuits during a functional test;

FIGS. 4-7 are schematic representations of circuit designs that include the combinational logic circuits and storage circuits in the logic circuit design in FIG. 1 and are updated to include clock gate circuits based on different groupings of the storage circuits;

FIG. 8 is a flowchart of a method of reducing power consumption in a logic circuit design as shown in FIG. 1, including grouping the storage circuits into first groups and second groups, generating updated versions of the logic circuit design with clock gate circuits inserted for each group, and selecting among the updated circuit designs based on test results;

FIG. 9 is a block diagram of an exemplary processor-based system that may be based on an updated circuit design in which power consumption is reduced by inserting clock gate circuits for a selected plurality of groups of the storage circuits.

FIGS. 10A through 18 illustrate aspects of a machine-learning-based approach for generating clock gate control logic, representing new subject matter introduced in this continuation-in-part application:

FIG. 10A is a block diagram illustrating an embodiment of a logic circuit and a device that is used to provide an updated version of the logic circuit;

FIG. 10B is a block diagram illustrating an embodiment of the updated version of the logic circuit of FIG. 10A;

FIG. 10C is a block diagram illustrating an embodiment of the system of FIG. 10B that includes registers groups;

FIG. 10D is a timing diagram illustrates waveforms of embodiments of signals from the logic circuit of FIG. 10C;

FIG. 11 is a block diagram showing an embodiment of a portion of a logic circuit design and a corresponding testbench interface for monitoring toggle activity of storage circuits during a simulation;

FIG. 12 is a block diagram illustrating an embodiment of use of a register adjacency matrix to generate a graph representation from toggle activity data;

FIG. 13A is a block diagram showing an embodiment of an inference phase of a trained graph neural network (GNN) model;

FIG. 13B is a block diagram illustrating an embodiment of the trained GNN model of FIG. 13A;

FIG. 14 is a block diagram illustrating an embodiment of training of the GNN model of FIG. 13A or FIG. 13B;

FIG. 15A is a block diagram of an embodiment of a reinforcement learning agent configured to receive graph embeddings and generate a clock gating control matrix as output;

FIG. 15B is a block diagram illustrating an embodiment of a particular neural architecture of the reinforcement learning agent of FIG. 15A;

FIG. 16 is a block diagram illustrating an embodiment of training of a reinforcement learning agent using toggle group generation;

FIG. 17 is a block diagram illustrating an embodiment of a reward generation process for training a reinforcement learning agent;

FIG. 18 is a block diagram illustrating an embodiment of providing an updated logic circuit based on a predicted clock-gating matrix;

FIG. 19A is a block diagram illustrating an embodiment of the generation of finite state machines based on an input design;

FIG. 19B is a flowchart of an example method for reducing power consumption in a logic circuit; and

FIG. 20 is a diagram illustrating a distributed computing environment capable of implementing aspects of the techniques and technologies presented herein.

### DETAILED DESCRIPTION

With reference to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Exemplary aspects disclosed herein include reducing power consumption in a logic circuit. Non-transitory computer readable storage medium storing instructions to reduce power consumption in a logic circuit is also disclosed. Reducing power consumption in a logic circuit design may include inserting clock gate circuits into the logic circuit design to selectively couple clock signals that are provided to sequential logic circuits (e.g., storage circuits). A storage circuit may be triggered (e.g., edge triggered or level triggered) by a clock signal and may consume power every time it is triggered by a clock signal. Clock gating is added to block the clock signal from triggering a storage circuit in conditions in which the storage circuit would not change state in response to being triggered by the clock signal.

An exemplary method of inserting clock gate circuits in a logic circuit design includes grouping (e.g., identifying groups of) storage circuits in the logic circuit design into a first plurality of groups and also grouping the storage circuits into a second plurality of groups, where the second plurality of groups has fewer groups than the first plurality of groups. The method includes inserting clock gate circuits into the logic circuit design based on the first plurality of groups to generate a first updated circuit design and based on the second plurality of groups to generate a second updated circuit design. The method also includes selecting one of the first updated circuit design and the second updated circuit design based on a comparison of test results of the first updated circuit design and the second updated circuit design. In some examples, the storage circuits may be grouped into the first plurality of groups based on storage circuits that toggle in a sequence of consecutive clock signal cycles. A logic circuit design may be selected from among multiple updated circuit designs in which storage circuits are clock gated in different groups to provide optimal power consumption.

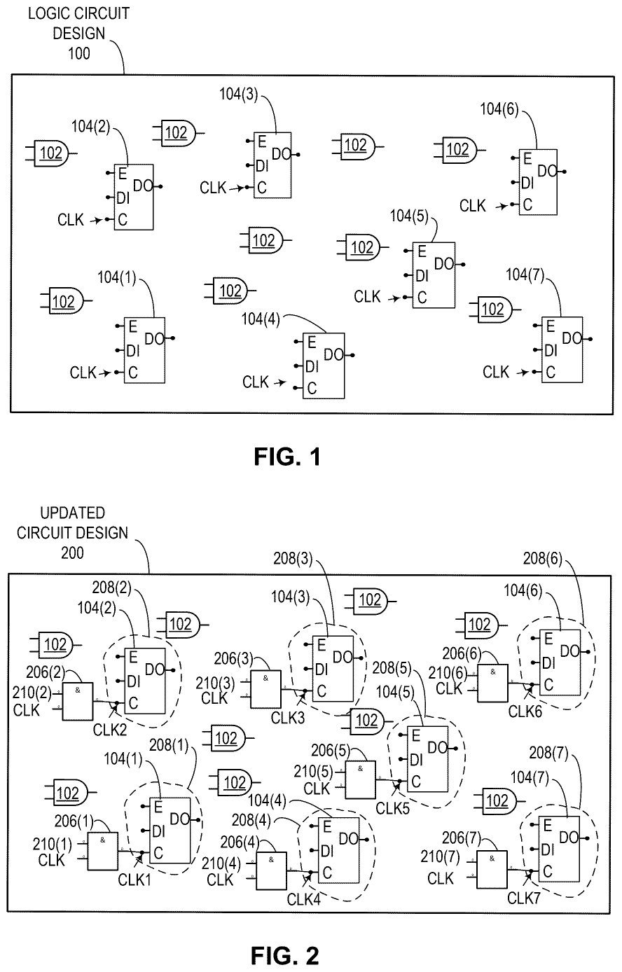

FIG. 1 is a schematic representation of a logic circuit design 100 including combinational logic circuits 102 and sequential logic circuits (e.g., storage circuits) 104(1)-104(N) (where N=7 in this example) without clock gate circuits to selectively couple a clock signal CLK to the storage circuits 104(1)-104(7). The logic circuit design 100 is intended to represent any logic circuit design including any number N of sequential logic circuits, such as storage circuits 104(1)-104(7), to which the methods disclosed herein may be applicable independent of a particular functionality. For this reason, and to avoid unnecessary complexity, FIGS. 1, 2, and 4-7 do not include features such as signal inputs, outputs, and interconnects between the combinational logic circuits 102 and/or the storage circuits 104(1)-104(7).

Signals driven by (e.g., outputs of) the combinational logic circuits 102 may change state, following a brief propagation delay through the combinational logic therein, in response to a change to the state(s) of one or more signals (e.g., inputs) provided to the combinational logic circuits, independent of the clock signal CLK. In contrast, signals driven by the storage circuits 104(1)-104(7) preserve a previously attained state and remain unchanged and independent of the states of signals provided to a data input DI and an enable input E until and in response to being triggered (e.g., “clocked”) by a clock signal CLK received at a clock input C. In some examples, the storage circuits 104(1)-104(7) may be triggered by a transition (e.g., “rising edge” or “falling edge”) of the clock signal CLK or by a level (e.g., voltage) of the clock signal CLK.

In the storage circuits 104(1)-104(7) shown in FIG. 1, a data output DO is driven to a same state as that of a data signal provided to the data input DI if an enable signal provided to the enable input E is in an active (e.g., enabling) state when the storage circuit is triggered by the clock signal CLK. In circumstances in which the storage circuits 104(1)-104(7) are triggered by the clock signal CLK but the enable input E is not in an active state, the data output DO would not change. However, whether or not the data output DO changes state in response to the clock signal CLK, the storage circuits 104(1)-104(7) may consume power each time the storage circuits 104(1)-104(7) are triggered by the clock signal CLK. In alternative examples of the logic circuit design 100, the storage circuits 104(1)-104(7) may exclude the enable input E, in which case a state of the data output DO is driven to a same state as the data input DI when (e.g., in response to) the storage circuits 104(1)-104(7) are triggered by the clock signal CLK. In such examples, when a state of the data input DI is the same as a state of the data output DO of one of the storage circuits 104(1)-104(7), power may still be consumed even though there is no change of state.

FIG. 2 is a schematic representation of an updated circuit design 200 including the combinational logic circuits 102 and the storage circuits 104(1)-104(N), where N=7 but may be any integer number of storage circuits. The updated circuit design 200 corresponds to the logic circuit design 100 in FIG. 1 and further includes individual clock gate circuits 206(1)-206(N) (where N=7 in this example) for each of groups 208(1)-208(N) (where N=7 in this example) of the storage circuits 104(1)-104(7). The clock gate circuits 206(1)-206(7) are provided to selectively couple (or block) the clock signal CLK to reduce power consumption. The clock gate circuits 206(1)-206(7) may be configured to allow the clock signal CLK to be received at the corresponding storage circuits 104(1)-104(7) under conditions in which a state of the data output DO is going to change. These conditions may be indicated by clock enable signals 210(1)-210(7). The clock enable signals 210(1)-210(7) may be generated based on a combination of signals provided to the enable inputs E and the data inputs DI of a corresponding one of the storage circuits 104(1)-104(7). In response to the clock enable signals 210(1)-210(7), the clock gate circuits 206(1)-206(7) may generate gated clock signals CLK1-CLK7 to trigger the storage circuits 104(1)-104(7), respectively.

In some examples, the clock gate circuits 206(1)-206(7) may be configured to prevent the clock signal CLK from being received at the corresponding storage circuits 104(1)-104(7) under some, most, or all conditions in which the state of the data output DO would not change. Thus, including the clock gate circuits 206(1)-206(7) allows functionality of the updated circuit design 200 to remain unchanged while preventing the storage circuits 104(1)-104(7) from being triggered unnecessarily and, thereby, preventing the storage circuits 104(1)-104(7) from consuming power when there is no change of state to the data output DO. In this manner, total power consumption of an integrated circuit (IC) that includes the updated circuit design 200 in FIG. 2 may be significantly reduced in comparison to an IC that includes the logic circuit design 100 in FIG. 1. In some examples, the updated circuit design 200 may be part of a larger logic circuit design on an IC.

Providing one of the clock gate circuits 206(1)-206(7) for each of the storage circuits 104(1)-104(7) may provide the greatest reduction in power consumption. However, inserting one of the clock gate circuits 206(1)-206(7) for each of the storage circuits 104(1)-104(7) may also have negative consequences, which may include degradation in signal timing in the updated circuit design 200 and/or increased circuit area of the updated circuit design 200. For example, degraded signal timing caused by the clock gate circuits 206(1)-206(7) may include an increase of propagation delays of signals to the data input DI, enable input E (if any), and the clock signal CLK, whether from another one of the storage circuits 104(1)-104(7) or from outside the updated circuit design 200. Another cause for degraded signal timing is increased delays of the clock signal CLK, which can decrease synchronization of the storage circuits 104(1)-104(7), reducing the time available for signals to propagate from one storage circuit to another. Increased circuit area can cause the size of an IC to be larger, which increases cost and may increase the size of an IC package. In still another aspect, incorrectly inserting the clock gate circuits 206(1)-206(7) may cause a reduction in functional quality due to functional errors in the updated circuit design 200. Thus, a method of reducing power consumption in a logic circuit design, while ensuring that functionality is not reduced, that timing requirements are satisfied, and that circuit area is not significantly increased, is needed.

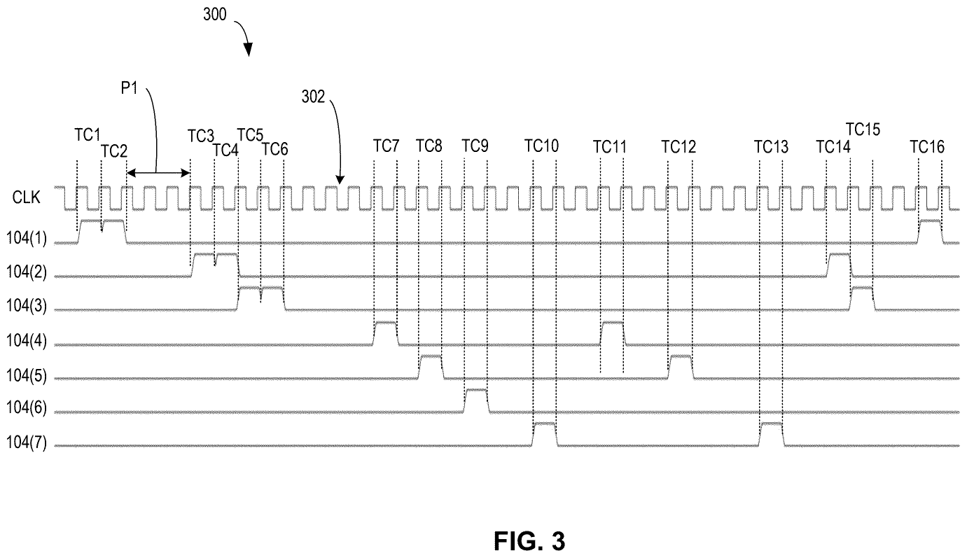

FIG. 3 is a timing diagram 300 illustrating toggling activity in the storage circuits 104(1)-104(7) in the logic circuit design 100 in FIG. 1 over multiple cycles 302 of the clock signal CLK provided to the storage circuits 104(1)-104(7) during a functional test. The expression “toggle”, “toggling,” “toggling event”, or “toggling activity” in this context refers to changes of the state(s) of the data output DO of at least one bit of a storage circuit, such as the storage circuits 104(1)-104(7). In particular, the storage circuits 104(1)-104(7) are digital logic circuits configured to store information in binary form, indicating a logical “0” or a logical “1.” Binary states may also be referred to as “low” and “high”, and may be represented by voltage levels maintained on the data outputs DO during periods of the clock signal CLK. For example, a logical “0” or “low” state may be represented by a low voltage (e.g., 0 volts) and a logical “1” or “high” state may be represented by a high voltage (e.g., 1.5 volts). In some examples, a logical “0” or “low” state may be represented by a high voltage and a logical “1” or “high” state may be represented by a low voltage. Additionally, each of the storage circuits 104(1)-104(7) may store multiple (e.g., from 1 to 64 or more, for example) binary digits (“bits”) representing control signals and/or data. Toggling one of the storage circuits 104(1)-104(7) that stores more than one bit of binary data refers to a cycle or occurrence of a change of at least one bit of such data. A toggling event is not limited to changes of the states of all bits or any particular number of bits, in excess of one bit, in a storage circuit.

The logic states of the storage circuits 104(1)-104(7) shown in the timing diagram 300 may be generated during a simulation of the logic circuit design 100 to represent expected operation of a logic circuit based on the logic circuit design 100 and inputs provided thereto. As shown in FIG. 3, the simulation causes the storage circuit 104(1) to toggle in a first toggle cycle TC1 and a second toggle cycle TC2 of the clock signal CLK. None of the storage circuits 104(1)-104(7) toggle during an inactive period P1 between the second toggle cycle TC2 and a third toggle cycle TC3. In toggle cycles TC3 and TC4, the storage circuit 104(2) toggles, immediately followed in toggle cycles TC5 and TC6 by toggling of the storage circuit 104(3). Due to the inactive period P1 between toggling of the storage circuit 104(1) and the storage circuit 104(2), it may be inferred that there is no relationship or dependency between the toggling of storage circuit 104(1) in toggle cycles TC1 and TC2 and the toggling of the storage circuits 104(2) and 104(3) in toggle cycles TC3-TC6. However, because the storage circuit 104(3) toggles in toggle cycles TC5 and TC6 immediately following the toggling of storage circuit 104(2) in toggle cycles TC3 and TC4, it may be inferred that there is a relationship or dependency between toggling of the storage circuit 104(2) and toggling of the storage circuit 104(3).

Based on the above, it may be inferred that there is no relationship between toggling of the storage circuits 104(4)-104(7) in toggle cycles TC7, TC8, TC9, and TC10, which are separated from each other by at least one cycle of the clock signal CLK. Also, toggling of storage circuits 104(4), 104(5), and 104(7) in toggle cycles TC11, TC12, and TC13, which are also separated from each other by at least one cycle of the clock signal CLK, may not indicate a relationship between such storage circuits. Based on toggle cycles TC14 and TC15, there is again an indication that toggling of the storage circuit 104(3) is dependent on the toggling of storage circuit 104(2), and toggle cycle TC16 does not indicate any toggling relationships or dependencies associated with storage circuit 104(1).

Thus, grouping of the storage circuits of the logic circuit design 100 into a first plurality of groups may include monitoring the storage circuits 104(1)-104(7) in a first test of the logic circuit design 100, identifying sequences of one or more consecutive cycles (e.g., of the clock signal CLK) during the first test in which at least one of the storage circuits 104(1)-104(7) toggles, and, for each sequence identified (such as TC3-TC6 and TC14-TC15), grouping the at least one of the storage circuits 104(1)-104(7) that toggled during the sequence into a first group among a plurality of groups that may be employed in an updated circuit design.

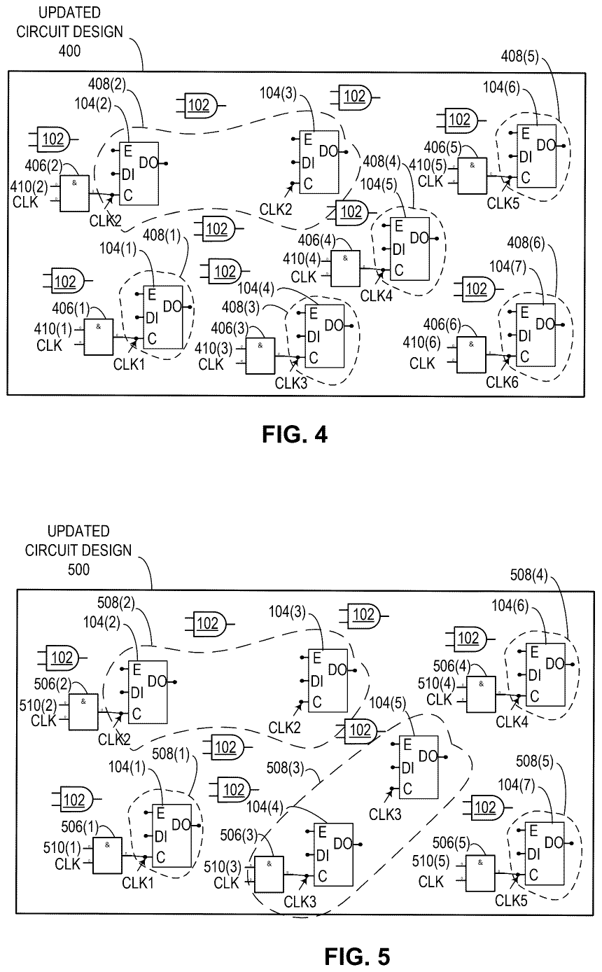

The inferred relationships or dependencies described above are based on sequences of toggling events in consecutive cycles of the clock signal. It should be noted, however, that these are merely inferences and may be shown to be incorrect. The timing diagram 300 is provided for reference to facilitate a description of a method for reducing power consumption in a logic circuit design, which also refers to FIGS. 4-7.

FIGS. 4-7 are schematic representations of updated circuit designs 400-700 that include the combinational logic circuits 102 and the storage circuits 104(1)-104(7) in the logic circuit design 100 in FIG. 1, and the updated circuit designs 400-700 are each updated to include clock gate circuits that gate the clock signal CLK to different groupings of the storage circuits 104(1)-104(7).

FIG. 4 is a schematic representation of a first updated circuit design 400 including clock gate circuits 406(1)-406(6). In contrast to the updated circuit design 200 in FIG. 2, which includes one of the clock gate circuits 206(1)-206(7) for each of the storage circuits 104(1)-104(7), the first updated circuit design 400 includes clock gate circuits 406(1)-406(6) for each of groups 408(1)-408(6). The clock gate circuit 406(2) selective couples (gates) the clock signal CLK to the group 408(2), which includes the storage circuits 104(2) and 104(3). The storage circuits 104(2) and 104(3) are grouped in the group 408(2) based on the relationship between the storage circuit 104(2) and the storage circuit 104(3) that is inferred by the sequence of toggling events in consecutive cycles TC3-TC6 in FIG. 3. The other storage circuits 104(1) and 104(4)-104(7) do not appear to have such relationships with each other or with the storage circuits 104(2) and 104(3) because there are no other sequences of toggle cycles occurring in consecutive cycles of the clock signal CLK in FIG. 3. Accordingly, each of the storage circuits 104(1) and 104(4)-104(7) are grouped into their own respective groups 408(1) and 408(3)-408(6), each comprising a single storage circuit, and the storage circuits in these groups are gated by corresponding clock gate circuits 406(1) and 406(3)-406(6).

Each of the clock gate circuits 406(1)-406(6) receives the clock signal CLK. The clock gate circuit 406(2) couples the clock signal CLK to each of the storage circuits 104(2) and 104(3) as a gated clock signal CLK2 in response to a clock enable signal 410(2). The clock enable signal 410(2) may be activated by the clock gate circuit 406(2) in conditions in which either the storage circuit 104(2) or the storage circuit 104(3) would toggle (e.g., change state) in response to the clock signal CLK. In cycles in which neither of the storage circuits 104(2) and 104(3) would have toggled in response to the clock signal CLK, power consumption can be reduced by blocking the clock signal CLK to the storage circuits 104(2) and 104(3) using the clock gate circuit 406(2). The clock gate circuit 406(1) couples the clock signal CLK to the storage circuit 104(1) as the gated clock signal CLK1. The clock gate circuits 406(3)-406(6) provide the clock signal CLK to the storage circuits 104(4)-104(7) as the gated clock signals CLK3-CLK6, respectively.

Since the storage circuits 104(2) and 104(3) toggle in the sequence of toggle cycles TC3-TC6 in FIG. 3, the clock gate circuit 406(2) may be enabled (e.g., to allow the clock signal CLK to propagate through the clock gate circuit 406(2)) to generate the gated clock signal CLK2 starting in the first toggle cycle TC3 and continuing through the last toggle cycle TC6 before being disabled. That is, the clock enable signal 410(2) may be activated based on a condition for toggling the storage circuit 104(2) in the toggle cycle TC3 and may remain active until the condition for enabling the storage circuit 104(3) in toggle cycle TC6. By such method, the storage circuit 104(2) will be triggered by the gated clock signal CLK2 in toggle cycles TC5 and TC6 even though the storage circuit 104(2) is not expected to toggle in toggle cycles TC5 and TC6. Similarly, the storage circuit 104(3) will be triggered by the gated clock signal CLK2 in toggle cycles TC3 and TC4 even though the storage circuit 104(3) may not toggle in those cycles. Thus, grouping the storage circuits 104(2) and 104(3) and providing a common gated clock signal CLK2 in this manner may still lead to unnecessary power consumption, but the grouping allows for a reduction in the number of clock gate circuits. This tradeoff may be considered beneficial to avoid a significant increase in the circuit area of the logic circuit design 100 that may occur when inserting clock gate circuits for each of the storage circuits, as shown in the updated circuit design 200. The benefit of grouping storage circuits to be triggered by the same gated clock signal may be increased, to some extent, by increasing the number of storage circuits in a group. However, as the number of storage circuits in a group increases, the amount of unnecessary power consumption may increase as well, and another method for grouping the storage circuits is needed. Thus, a method of generating and evaluating prospective groups of storage circuits is needed.

FIG. 5 is a schematic representation of a second updated circuit design 500 based on the logic circuit design 100 in FIG. 1. The updated circuit design 500 includes the combinational logic circuits 102 and the storage circuits 104(1)-104(7) and is updated, relative to the logic circuit design 100 in FIG. 1, to include clock gate circuits 506(1)-506(5) based on grouping the storage circuits 104(1)-104(7) in a second plurality of groups. Here the storage circuit 104(1) is in a group 508(1) and the storage circuits 104(2) and 104(3) are in group 508(2). The storage circuit 104(4) is prospectively grouped with the storage circuit 104(5) in a group 508(3) and the storage circuits 104(6) and 104(7) are in individual groups 508(4) and 508(5). An alternative grouping is employed in FIG. 5 compared to the grouping in FIG. 4, to provide the second plurality of groups 508(1)-508(5) having fewer groups than the first plurality of groups 408(1)-408(6). Since there is one of the clock gate circuits 506(1)-506(5) provided for each of the groups 508(1)-508(5), the reduced number of groups compared to FIG. 4 provides a reduction in the number of clock gate circuits while still achieving a reduction in power consumption. The clock gate circuits 506(1)-506(5) generate, when appropriately enabled, gated clock signals CLK1-CLK5, which are distributed to the storage circuits 104(1)-104(7) according to the groups 508(1)-508(5).

As described above in FIG. 4, the storage circuits 104(2) and 104(3) are grouped together in group 408(2) based on consecutive cycles TC3-TC6 in which storage circuit 104(3) toggles in toggle cycle TC5 immediately following toggling in storage circuit 104(2) in toggle cycle TC4, which appears to indicate a dependent relationship. The other storage circuits 104(1) and 104(4)-104(7) do not appear to have such relationships with each other or with the storage circuits 104(2) and 104(3) because there are no other sequences of toggle cycles occurring in consecutive cycles of the clock signal CLK in FIG. 3. Accordingly, any further grouping of the storage circuits 104(1) and 104(4)-104(7), such as the group 508(3), is not based on an inference of a relationship due to back to back toggle cycles and may be developed by any appropriate method.

One method for further grouping the storage circuits 104(1)-104(7) may include an iterative approach with a progressively increasing scope. That is, initially, each group may be prospectively grouped with one additional group, which means that each of the storage circuits 104(1)-104(7) may initially be prospectively grouped with each of the other storage circuits 104(1)-104(7). The groups 508(1)-508(5) may have been determined in this manner.

A prospective updated circuit design may be generated based on each of such prospective groupings, and tests may be executed on each updated circuit design to determine whether the resultant clock gating affects circuit function. To be more specific, since a gated clock signal is provided to the storage circuits in a group during a window of time beginning with conditions in which a first one of the storage circuits toggles and ending with conditions in which a last one of the storage circuits toggles, any intermediate storage circuits in the group (other than the first and last) is limited to being triggered only during one of such windows. If a storage circuit in the group is expected to toggle outside of such window (e.g., not following a toggle of the first one of the storage circuits) during a functional test, that functional test may indicate an error because that intermediate storage circuit would not be triggered. Such failure of a prospective grouping indicates that an updated circuit design based on the prospective grouping has a lower functional quality and may not be acceptable for generating an IC. In view of this, another method of grouping the storage circuits 104(1)-104(7) into a second plurality of groups 508(1)-508(5) may be employed.

In another example, a method may include, for each previously identified group (e.g., of the groups 408(1)-408(6)), determining whether the toggling of the storage circuits 104(1)-104(7) of a second group of the first plurality of groups 408(1)-408(6) is dependent on or independent from the toggling of the storage circuits 104(1)-104(7) of the first group, and grouping the storage circuits 104(1)-104(7) of the first group and the second group into a third group of the second plurality of groups 508(1)-508(5) if the storage circuits 104(1)-104(7) of the second group do not toggle independently from the first group. A clock gate circuit may be inserted into the logic circuit design to provide a gated clock signal to all the storage circuits in the third group. A finite state machine (FSM) may be added to the logic circuit design to generate the gate enable signal, which may be activated for a sequence of cycles of the clock signal CLK that includes the toggling of all the storage circuits in the third group. The FMS may activate the gate enable signal for a clock gate circuit of the third group in a cycle of the clock signal CLK in which there is a condition for a first storage circuit of the third group to toggle in the sequence of cycles, and the FSM may keep the gate enable signal active until a cycle in which the last the storage circuit of the third group toggles in the sequence.

Another consideration in generating a plurality of groups for a circuit design is whether a prospective grouping (plurality of groups) reduces the number of clock gate circuits (e.g., and groups) compared to a previous grouping. Since an objective of regrouping the storage circuits is to reduce a number of the clock gate circuits, a prospective grouping may be rejected if it does not reduce the number of groups.

Based on these two different pluralities of groups, the first updated circuit design 400 and the second updated circuit design 500 may be generated. Generating the updated circuit design 400 includes inserting clock gate circuits 406(1)-406(6) into the logic circuit design 100, where each of the clock gate circuits 406(1)-406(6) is configured to selectively couple the clock signal CLK to the storage circuits 104(1)-104(7) in a corresponding group of the first plurality of groups 408(1)-408(6). Generating the second updated circuit design 500 includes inserting clock gate circuits 506(1)-506(5) into the logic circuit design 100, where each of the clock gate circuits 506(1)-506(5) is configured to selectively couple the clock signal CLK to the storage circuits 104(1)-104(7) in a corresponding group of the second plurality of groups 508(1)-508(5).

One of the updated circuit design 400 and the updated circuit design 500 may be selected as preferable for use in an IC. Selecting one of these updated circuit designs may be based on a comparison of power consumption of a first updated circuit design and a second updated circuit design, such as the updated circuit designs 400 and 500, according to a first result of the first updated circuit design and a second result of the second updated circuit design. That is, a functional test (e.g., regression simulation) is executed in the updated circuit design 400 and also executed in the updated circuit design 500. The test results may be used to gather various information about the respective updated circuit designs 400 and 500. In addition to confirming that both updated circuit designs 400 and 500 are functionally equivalent (or substantially equivalent) to the logic circuit design 100, the test results may also provide information regarding power consumption and signal timing (e.g., propagation delay). In another aspect, updated physical design information may be generated from the updated circuit designs 400 and 500 and compared to the original logic circuit design 100 to determine respective increases in circuit area of the updated circuit designs 400 and 500 compared to the logic circuit design 100. As an example, a difference (Delta) between the updated circuit design 400 and the original logic circuit design 100 may be calculated by the following:

$$Delta = α ( Function 400 - Function 100 ) + β ( Power 400 - Power 100 ) + γ ( Timing 400 - Timing 100 ) + δ ( Area 400 - Area 100 ) ,$$

where:
α, β, γ, and δ are weights for Function, Power, Timing, and Area, respectively;
Function400 and Function100 indicate function quality;
Power400 and Power100 indicate power consumption;
Timing400 and Timing100 indicate timing quality; and
Area400 and Area100 indicate circuit area.

In some examples, other characteristics (other than Function, Power, Timing, and Area) of the respective updated circuit designs 400 and 500 may be compared to the original logic circuit design 100, or compared to each other, as a basis for selecting one updated circuit design as a selected or preferred design. The selected design may provide an improved balance of lower power consumption, performance, and area in an IC that is manufactured based on the selected design. For example, the selected design may be selected based on a weighted comparison of power consumption and functional quality in the test results, where power consumption is indicated by the variables Power400 and Power100 and functional quality is indicated by the variables Function400 and Function100. The selected design may be selected based on a weighted comparison of power consumption and signal timing in the test results, where power consumption is indicated by the variables Power400 and Power100 and signal timing is indicated by the variables Timing400 and Timing100. The selected design may be selected based on a weighted comparison of power consumption and circuit area in the test results, where power consumption is indicated by the variables Power400 and Power100 and circuit area is indicated by the variables Area400 and Area100.

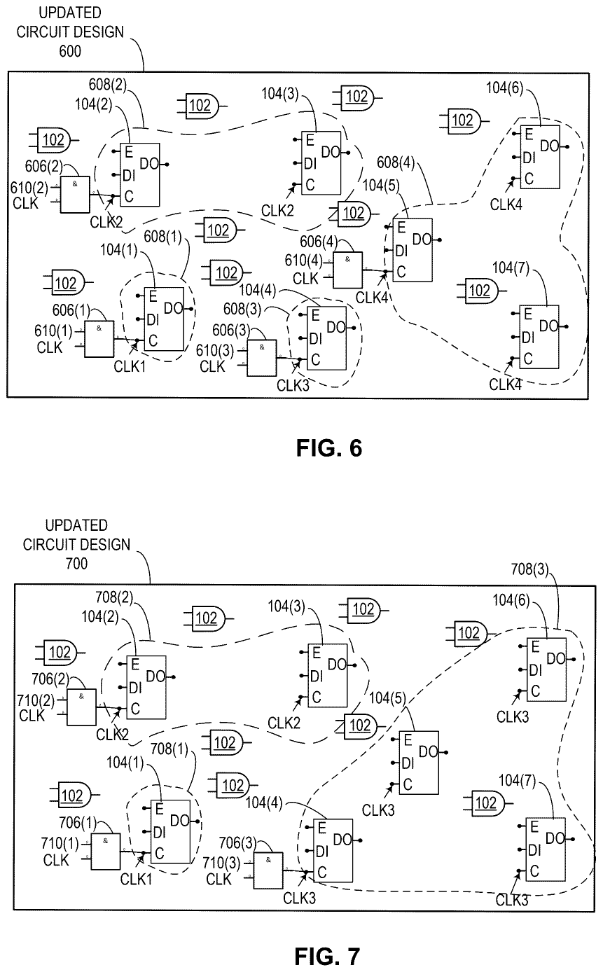

Based on comparisons of the test results, which may include a calculation of the “Delta” shown above, one of the updated circuit designs 400 and 500 may be determined to be preferable and may be selected for use. Alternatively, as shown in FIGS. 6 and 7, additional updated circuit designs 600 and 700 may be generated based on grouping the storage circuits 104(1)-104(7) in a new plurality of groups, each having fewer groups than the plurality of groups in the updated circuit designs 400 and 500. As noted above, each of the storage circuits 104(1)-104(7) may initially be iteratively grouped with one of each of the other storage circuits to create the groups 508(1)-508(5). Such iterative grouping may be performed by any appropriate algorithm that explores (e.g., generates and tests) possible grouping options. After testing options of one-to-one prospective groupings, an iterative approach may be expanded to prospectively group the storage circuits 104(1)-104(7) in larger groups, to reduce the total number of groups. This may lead to combining existing groups. In each iteration, one storage circuit may be prospectively grouped with two storage circuits, followed by prospective grouping with three storage circuits, and so on in increasing numbers of storage circuits, where each grouping is tested for function and may be rejected if it does not lead to a reduction in the total number of groups. This approach may lead to the pluralities of groups illustrated in FIGS. 6 and 7.

FIG. 6 is a schematic representation of another updated circuit design 600 based on the logic circuit design 100 in FIG. 1. The updated circuit design 600 includes the combinational logic circuits 102 and the storage circuits 104(1)-104(7) and is updated to include clock gate circuits 606(1)-606(4) based on a plurality of groups 608(1)-608(4) of the storage circuits 104(1)-104(7). Here the storage circuit 104(1) is in a group 608(1) and the storage circuit 104(4) is in a group 608(3), each including a single storage circuit. As in FIGS. 4 and 5, the storage circuits 104(2) and 104(3) are grouped together due to their inferred relationship in group 608(2). However, in contrast to FIG. 5, storage circuit 104(5) is grouped with the storage circuits 104(6) and 104(7) in group 608(4). The plurality of groups employed in FIG. 6 comprises fewer groups than the first plurality of groups 408(1)-408(6) in FIG. 4 and the second plurality of groups 508(1)-508(5) in FIG. 5. Accordingly, the number of clock gate circuits 606(1)-606(4) is reduced while continuing to provide a reduction in power consumption compared to the original logic circuit design 100. The clock gate circuits 606(1)-606(4) generate, when respectively enabled, gated clock signals CLK1-CLK4, which are distributed to the storage circuits 104(1)-104(7) according to the groups 608(1)-608(4).

FIG. 7 is a schematic representation of another updated circuit design 700 based on the logic circuit design 100 in FIG. 1. The updated circuit design 700 includes the combinational logic circuits 102 and the storage circuits 104(1)-104(7) and is updated to include clock gate circuits 706(1)-706(3) based on a plurality of groups 708(1)-708(3) of the storage circuits 104(1)-104(7). In this example, the storage circuit 104(1) is in the group 708(1), the storage circuits 104(2) and 104(3) are grouped together in group 708(2), and the remaining storage circuits 104(4)-104(7) are grouped in group 708(3). The clock gate circuits 706(1)-706(3) receive the clock signal CLK and distribute, when respectively enabled, gated clock signals CLK1, CLK2, and CLK3 to the storage circuits 104(1)-104(7) according to the groups 708(1)-708(3). The plurality of groups employed in FIG. 7 comprises fewer clock gate circuits, according to the number of groups, to reduce circuit area compared to the updated circuit designs 400, 500, and 600, while continuing to provide some reduction in power consumption compared to the original logic circuit design 100.

In the updated circuit design 700, the clock gate circuit 706(3) may be inserted into the logic circuit design 100 to provide the gated clock signal CLK3 to all the storage circuits 104(4)-104(7) in the group 708(3). An FSM (not shown) may be added to the updated circuit design 700 to generate a gate enable signal 710(3) to cause the clock gate circuit 706(3) to pass the clock signal CLK to the storage circuits 104(4)-104(7) as the gated clock signal CLK3. The gate enable signal 710(3) may be activated for a sequence of cycles of the clock signal CLK that includes the toggling of all the storage circuits in the third group. The FSM may activate the gate enable signal 710(3) for a clock gate circuit of the third group 708(3) in a cycle of the clock signal CLK in which there is a condition for a first storage circuit of the third group to toggle in the sequence of cycles, and the FSM may keep the gate enable signal 710(3) active until a cycle in which the last storage circuit of the third group 708(3) toggles in the sequence.

For example, referring again to FIG. 3, an FSM may activate the gate enable signal 710(3) in the toggle cycle TC7 and keep the gate enable signal 710(3) active until the toggle cycle TC10. Then the FSM may activate the gate enable signal 710(3) again in the toggle cycle TC11 and keep the gate enable signal 710(3) active until the toggle cycle TC13.

Although the reduced number of groups and, therefore, clock gate circuits reduces the circuit area of the updated circuit designs 400-700 compared to the updated circuit design 200 in FIG. 2, the reduction in the number of groups may lead to inefficiencies in the reduction in power consumption. For example, with additional reference to FIG. 3, between toggle cycles TC8 and TC10, the storage circuit 104(6) toggles in toggle cycle TC9. Thus, sharing a clock gate circuit 706(3) among the storage circuits 104(4)-104(7) reduces the circuit area and allows each of the storage circuits 104(4)-104(7) to be triggered in a window of time from toggle cycle TC7 to TC10 but not to be triggered outside this window. However, between toggle cycles TC12 and TC13, in which storage circuits 104(5) and 104(7) toggle again, the storage circuit 104(6) does not toggle. Therefore, providing the gated clock signal CLK3 to trigger the storage circuit 104(6) during the window from the toggle cycle TC11 to toggle cycle TC13 causes the storage circuit 104(6) to be unnecessarily triggered and consume power. Accordingly, as shown in the calculation of Delta, above, the selection of an updated circuit design is based on a balance of characteristics that may be affected by grouping the storage circuits and providing clock gate circuits for each group.

As illustrated in FIGS. 6 and 7, a method of reducing the power consumption in the logic circuit design 100 may include grouping the storage circuits 104(1)-104(7) of the logic circuit design 100 into a third plurality of groups 608(1)-608(4), wherein the third plurality of groups 608(1)-608(4) comprises fewer groups than the second plurality of groups 508(1)-508(5), comprising, for each third group of the second plurality of groups 508(1)-508(5), determining that the toggling of the storage circuits of a fourth group of the second plurality of groups 508(1)-508(5) is dependent on toggling of the storage circuits of the third group; and grouping the storage circuits of the third group and the fourth group into a fifth group of the third plurality of groups 608(1)-608(4). The method of reducing the power consumption further includes generating a third updated circuit design 600 comprising third clock gate circuits 606(1)-606(4) inserted into the logic circuit design 100, wherein each third clock gate circuit 606(1)-606(4) is configured to selectively couple the clock signal to the storage circuits 104(1)-104(7) in a group of the third plurality of groups 608(1)-608(4). Selecting an updated circuit design may include selecting one of a first updated circuit design 400, a second updated circuit design 500, and a third updated circuit design 600 as a selected circuit design based on a comparison of a first result of a first test executed on the first updated circuit design 400, a second result of the first test executed on the second updated circuit design 500, and a third result of the first test executed on the third updated circuit design 600.

It should be understood that the methods described herein are not limited to a particular logic circuit design or to the specific groups, number of groups or group sizes described herein. In an actual logic circuit design updated according to the discussion herein, there may be tens, hundreds, or thousands of storage circuits in a logic circuit design or in any of the groups in a plurality of groups. In addition, there may be any appropriate number of groups in a logic circuit design. Furthermore, a logic circuit design may include fewer or more combinational logic circuits and/or storage circuits than the logic circuit design 100. The term “storage circuits” as used herein refers to sequential logic circuits, which may include registers, flip-flops, latches, etc. that may contain any integer number of “bits” of digital information. A sequential logic circuit may include circuits that maintain a voltage level on an output after being triggered by a clock signal in a first cycle of the clock signal until being triggered again by the clock signal in a next cycle of the clock signal, independent of changes to the states of other inputs to the sequential logic circuit.

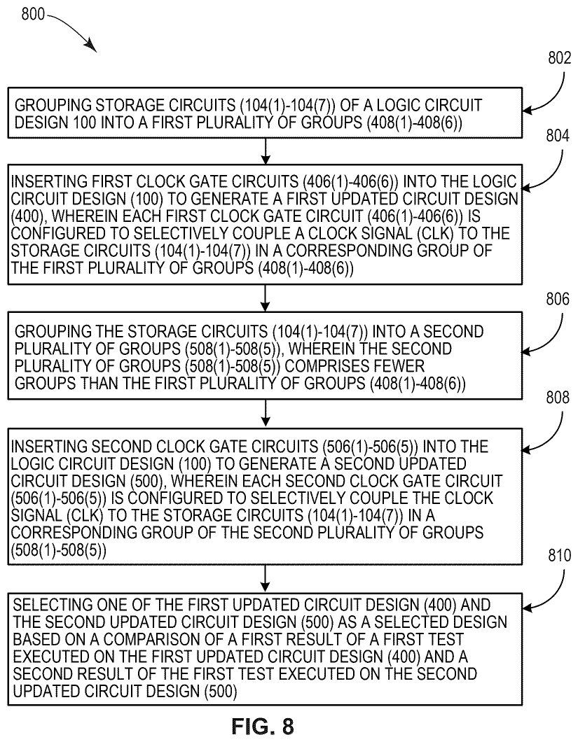

FIG. 8 is a flowchart of a method 800 of reducing power consumption in a logic circuit design. The method 800 includes grouping storage circuits 104(1)-104(7) of a logic circuit design 100 into a first plurality of groups 408(1)-408(6) (block 802) and inserting first clock gate circuits 406(1)-406(6) into the logic circuit design 100 to generate a first updated circuit design 400, wherein each first clock gate circuit (406(1)-406(6)) is configured to selectively couple a clock signal CLK to the storage circuits 104(1)-104(7) in a corresponding group of the first plurality of groups 408(1)-408(6) (block 804). The method includes grouping the storage circuits 104(1)-104(7) into a second plurality of groups 508(1)-508(5), wherein the second plurality of groups 508(1)-508(5) comprises fewer groups than the first plurality of groups 408(1)-408(6) (block 806) and inserting second clock gate circuits 506(1)-506(5) into the logic circuit design 100 to generate a second updated circuit design 500, wherein each second clock gate circuit 506(1)-506(5) is configured to selectively couple the clock signal CLK to the storage circuits 104(1)-104(7) in a corresponding group of the second plurality of groups 508(1)-508(5) (block 808). The method also includes selecting one of the first updated circuit design 400 and the second updated circuit design 500 as a selected design based on a comparison of a first result of a first test executed on the first updated circuit design 400 and a second result of the first test executed on the second updated circuit design 500 (block 810).

Another method of reducing power consumption in a logic design may include parsing a logic circuit design (e.g., in register transfer language (RTL) format) to identify storage circuits in the logic design, modifying a test interface to monitor state changes of the storage circuits in the logic circuit design during a test, and performing a regression test of the logic circuit design. The method may further include grouping the storage circuits into first groups based on sequences of toggle events and grouping the storage circuits into second groups, which includes combining the first groups. The method further includes inserting clock gate circuits into the logic circuit design for each of the second groups to generate an updated logic circuit design and performing the regression test of the updated logic circuit design. The method also includes comparing results of the regression test of the logic circuit design and the updated logic circuit design to determine a difference (Delta) of the updated logic circuit design.

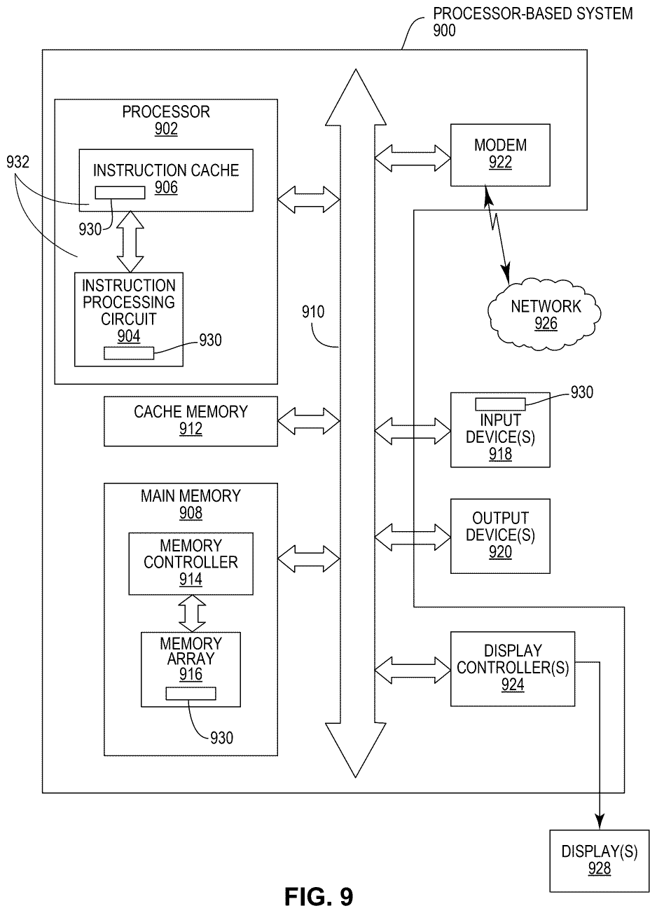

FIG. 9 is a block diagram of an exemplary processor-based system 900 that includes a processor 902 (e.g., a microprocessor), including an instruction processing circuit 904. The processor-based system 900 may include integrated circuits on an electronic board or card, such as a printed circuit board (PCB), in a server, a personal computer, a desktop computer, a laptop computer, a personal digital assistant (PDA), a computing pad, a mobile device, or any other device, and may represent, for example, a server or a user's computer. In this example, the processor-based system 900 includes the processor 902. The processor 902 represents one or more general-purpose processing circuits, such as a microprocessor, central processing unit, or the like. More particularly, the processor 902 may be an EDGE instruction set microprocessor or other processor implementing an instruction set that supports explicit consumer naming for communicating produced values resulting from the execution of producer instructions.

The processor 902 is configured to execute instructions for performing the operations and steps discussed herein. In this example, the processor 902 includes an instruction cache 906 for temporary, fast access memory storage of instructions accessible by the instruction processing circuit 904. Fetched or prefetched instructions from a memory, such as a main memory 908, over a system bus 910, are stored in the instruction cache 906. Data may be stored in a cache memory 912 coupled to the system bus 910 for low-latency access by the processor 902. The instruction processing circuit 904 is configured to process instructions fetched into the instruction cache 906 and process the instructions for execution.

The processor 902 and the main memory 908 are coupled to the system bus 910 and can intercouple peripheral devices included in the processor-based system 900. As is well known, the processor 902 communicates with these other devices by exchanging address, control, and data information over the system bus 910. For example, the processor 902 can communicate bus transaction requests to a memory controller 914 in the main memory 908 as an example of a controlled device. Although not illustrated in FIG. 9, multiple system buses 910 could be provided, wherein each system bus 910 constitutes a different fabric. In this example, the memory controller 914 is configured to provide memory access requests to a memory array 916 in the main memory 908. The memory array 916 is comprised of an array of storage bit cells for storing data. The main memory 908 may be a read-only memory (ROM), flash memory, dynamic random-access memory (DRAM), such as synchronous DRAM (SDRAM), etc. and/or static memory (e.g., flash memory, SRAM, etc.), as non-limiting examples.

Other devices can be connected to the system bus 910. As illustrated in FIG. 9, these devices can include the main memory 908, one or more input device(s) 918, one or more output device(s) 920, a modem 922, and one or more display controllers 924, as examples. The input device(s) 918 can include any type of input device, including but not limited to input keys, switches, voice processors, etc. The output device(s) 920 can include any type of output device, including but not limited to audio, video, other visual indicators, etc. The modem 922 can be any device configured to allow an exchange of data to and from a network 926. The network 926 can be any type of network, including but not limited to a wired network (e.g., ethernet) or wireless network, a private or public network, a local area network (LAN), a wireless local area network (WLAN), a wide area network (WAN), a BLUETOOTH™ network, and the Internet. The modem 922 can be configured to support any type of communications protocol desired. The processor 902 may also be configured to access the display controller(s) 924 over the system bus 910 to control information sent to one or more displays 928. The display(s) 928 can include any type of display, including but not limited to a cathode ray tube (CRT), a liquid crystal display (LCD), a plasma display, etc.

The processor based system 900 may include one or more logic circuit designs based on a selected updated circuit design in which power consumption is reduced according to the methods disclosed herein.

The processor-based system 900 in FIG. 9 may include a set of instructions 930 to be executed by the processor 902 for any application desired according to the instructions. The instructions 930 may be stored in the main memory 908, the processor 902, and/or the instruction cache 906 as examples of a non-transitory computer-readable medium 932. The instructions 930 may also reside, completely or at least partially, within the main memory 908 and/or within the processor 902 during their execution. The instructions 930 may further be transmitted or received over the network 926 via the modem 922, such that the network 926 includes the computer-readable medium 932.

While the computer-readable medium 932 is shown in an exemplary embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the processing device and that causes the processing device to perform any one or more of the methodologies of the embodiments disclosed herein. The term “computer-readable medium” shall accordingly be taken to include, but not be limited to, solid-state memories, optical medium, and magnetic medium.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, computer-readable storage medium, computer-readable storage device, or computer storage medium.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

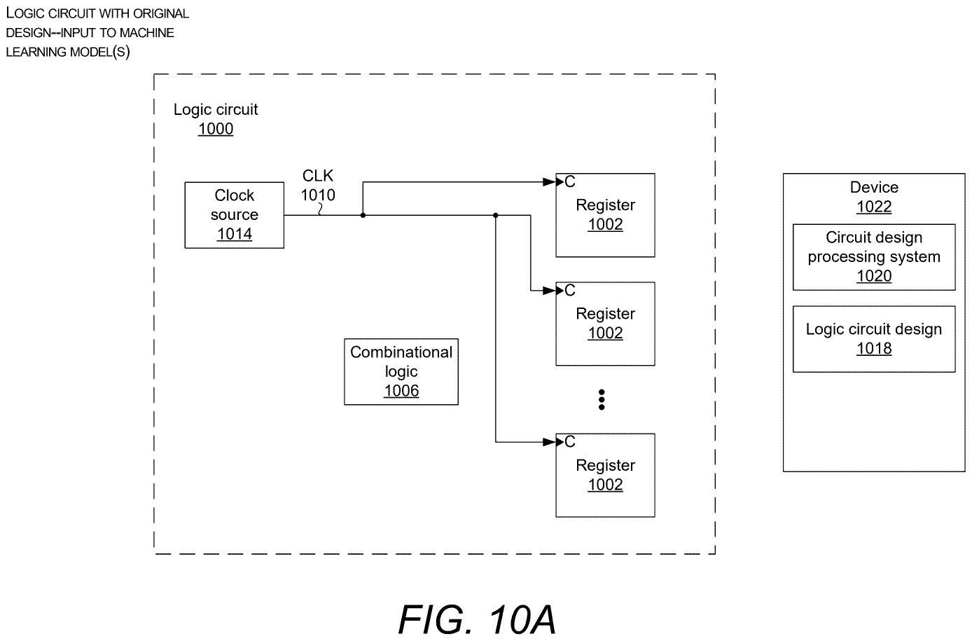

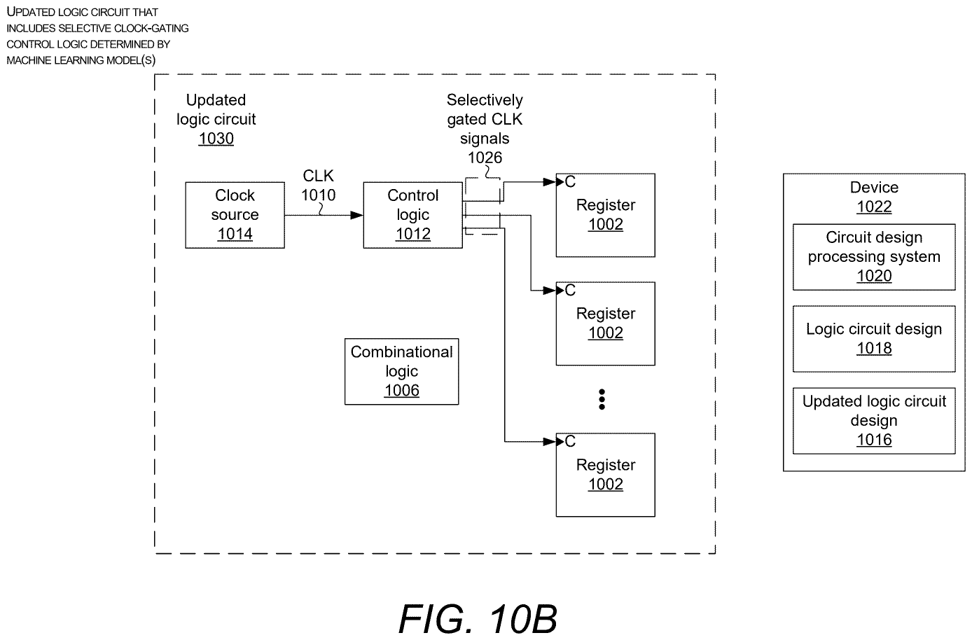

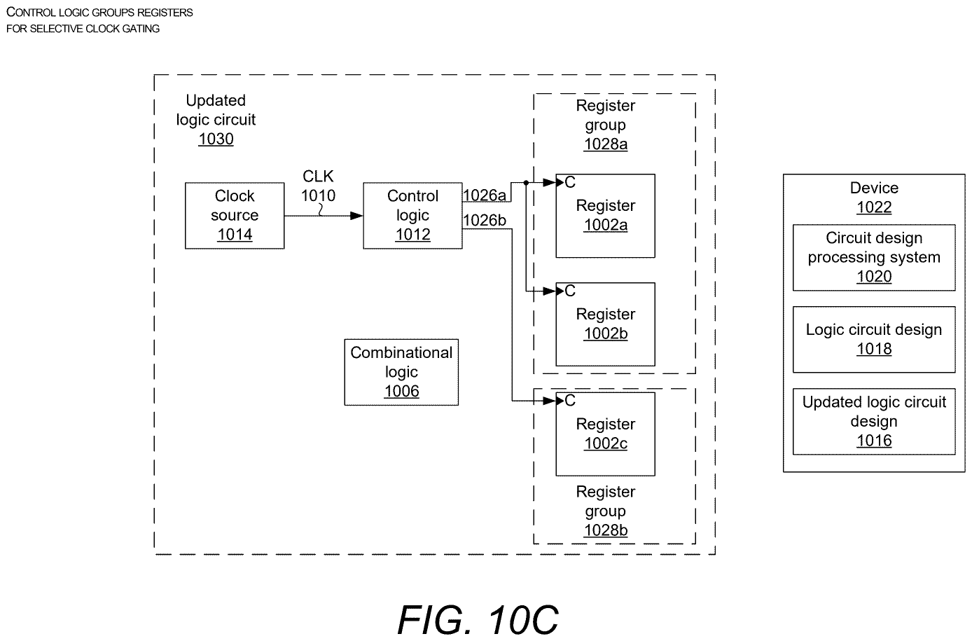

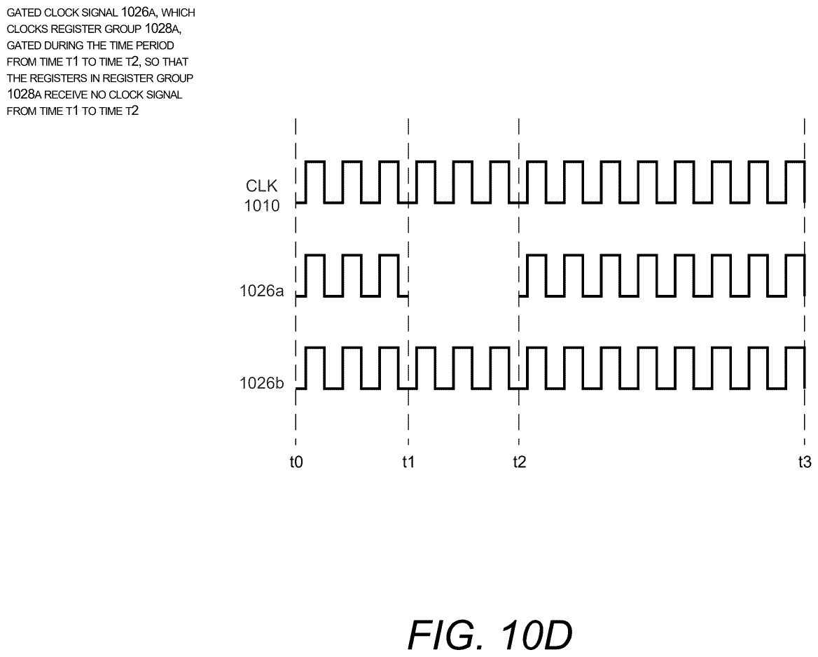

The present continuation-in-part (CIP) application includes additional disclosure relating to machine-learning-based techniques for selectively gating clock signals in logic circuits to reduce power consumption. The techniques disclosed herein expand on the prior application by introducing reinforcement learning (RL) agents, graph neural networks (GNNs), and associated preprocessing algorithms. This section also references additional figures (FIGS. 10A-20), which illustrate the operation and structure of the disclosed embodiments.

The processor based system 900 may include or be coupled to any type of processor-executable media such as processor-readable storage media (e.g., the computer-readable medium 932) and communication media (e.g., communication signals and radio waves). While the term processor-readable storage media includes the computer-readable medium 932, the term “processor-readable storage media,” throughout the specification and the claims, whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Some examples of the computing device 900 include at least one memory (e.g., the computer-readable medium 932) having processor-executable code stored therein, and at least one processor (e.g., the processor 902) that is adapted to execute the processor-executable code, wherein the processor-executable code includes processor-executable instructions that, in response to execution, enables the computing device 900 to perform actions, where the actions may include, in some examples, actions for one or more processes described herein, such as any of the processes discussed with regard to FIGS. 10A-19B.

In some embodiments, machine learning is used to provide improved clock gating in the design of logic circuits. For example, a representative logic circuit (1000) and a device (1022) that may be used in conjunction with the disclosed techniques is shown in FIG. 10A. The logic circuit 1000 includes storage circuits (1002) such as registers, each coupled to receive a clock signal 1010 at a clock input (C). Although the storage circuits 1002 will be referred to interchangeably herein as storage circuits 1002 or registers 1002, it will be understood that the storage circuits 1002 may be storage circuits other than registers. Each clock signal 1010 is generated by a respective clock source (1014). Combinational logic (1006) generates inputs to the storage circuits 1002, which in turn produce outputs that feed back into the combinational logic 1006, forming a synchronous circuit topology. The logic circuit design 1000 is intended to represent any logic circuit design including any number sequential logic circuits, such as storage circuits 1002, along with any suitable combinational logic 1006, to which the methods disclosed herein may be applicable independent of a particular functionality. For this reason, and to avoid unnecessary complexity, FIGS. 10A-10D do not include features such as signal inputs, outputs, and interconnects between the combinational logic circuits 102 or the device 1022 and other components.

The logic circuit 1000 implements both combinational logic and sequential logic. The sequential logic includes state-holding elements such as storage circuits 1002. The storage circuits 1002 may include registers (e.g., flip-flops or latches) that are configured to store state information and update based on one or more received timing signals such as one or more clock signals (1010).

A clock signal is a periodic waveform that coordinates the timing of state transitions in the storage circuits 1002. Even when the stored state information remains unchanged, the receipt of a clock signal 1010 can cause power consumption due to switching activity at internal nodes. Selectively gating clock signals—i.e., suppressing delivery of clock signals to storage circuits predicted to retain their state—can therefore reduce power usage without affecting functional correctness.

The behavior of the logic circuit 1000 is defined using a hardware description language (HDL) such as Verilog or Very High-Speed Integrated Circuit HDL (VHDL). The HDL code specifies the structure and behavior of the circuit, including the interconnection of the combinational logic 1006, registers 1002, and clock paths of the clock signals 1010. This HDL-based specification is referred to as a logic circuit design (1018). The logic circuit design 1018 is stored on the device 1022.

In some embodiments, the device 1022 includes a circuit design processing system (1020) that performs some of the steps discussed herein. The circuit design processing system 1020 is a specialized computing environment configured for processing, simulation, and optimization of electronic circuit designs and machine-learning tasks. The circuit design processing system 1020 may be implemented as a dedicated computing platform or a high-performance computing system optimized for electronic design automation (EDA) tasks and machine-learning tasks. The circuit design processing system 1020 includes one or more processors, system memory, and a processor-executable storage medium containing processor-executable code. This processor-executable code, when executed, causes the system to perform various actions discussed herein.

The circuit design processing system 1020 further includes specialized hardware such as tensor processing units (TPUs) or other parallel processing architectures that accelerate machine learning and simulation operations. In some configurations, the circuit design processing system 1020 includes a compute cluster or distributed architecture tailored to support the computational demands of large-scale integrated circuit design. Additionally, the circuit design processing system 1020 is tightly integrated with industry-standard EDA tools, enabling seamless transitions from design optimization to hardware description language (HDL) synthesis, verification, and physical implementation. As such, the circuit design processing system 1020 is not merely a generic computing device but a purpose-built infrastructure for executing at least some of the disclosed methods within the domain of hardware design and machine-learning-driven optimization.

Although the device 1022 is shown as a single device, in various embodiments, the device 120 may be one device that is included within one or more distributed systems that perform various actions indicated herein.

In some embodiments, actions performed by the circuit design processing system 1020 cause control logic (1012) to be determined. After the control logic 1012 is determined, the control logic 1012 is inserted into the logic circuit 1000, causing the logic circuit 1000 to become an updated logic circuit (1030) as illustrated in FIG. 10B.

FIG. 10B shows the updated logic circuit 1030. The updated logic circuit 1030 is an updated version 1030 of the logic circuit 1000 of FIG. 10A. The updated logic circuit 1030 is different from logic circuit 1000 in that updated logic circuit 100 includes the control logic 1012, which performs clock gating. As explained in greater detail below, the control logic 1012 is determined by a machine learning model, such as a trained reinforcement learning agent, that is executed on one or more devices, including the device 1022. The control logic 1012 is incorporated into the design 1018 to provide an updated version 1016 of the design and incorporated into the logic circuit 1000 to provide an updated version 1030 of the logic circuit. The control logic 1012 includes clock-gating logic that reduces power consumption in the control circuit 1000, as explained in greater detail below.

The control logic 1012 performs selective gating of the clock signal 1010 to each of the registers 1002, which reduces power consumption. However, if the control logic 1012 performed the selective gating of the clock signal 1010 to each the registers 1002 entirely independently of each other, this could result in excessive circuit area in the updated logic circuit 1030. The control logic 1012 therefore makes use of groups of the registers 1002 that receive common gated clock signals among the gated clock signals 1026, as illustrated in FIG. 10C according to one embodiment.

FIG. 10C illustrates an embodiment of the updated logic circuit 1030 in which the registers 1002 are grouped into register groups (1028) by the control logic 1012. In the embodiment illustrated in FIG. 10C, a first register 1002a and a second register 1002b are grouped into a first register group 1028a. A third register 1002c is grouped by itself into a second register group 1028b. The control logic circuit 1012 provides selective clock gating for the registers 1002 by providing gated clock signals 1026. The gated clock signals 1026 include a first gated clock signal 1026a and a second gated clock signal 1026b. The first gated clock signal 1026a is provided to the clock input C of each register in the first register group 1028a, and the second gated clock signal 1026b is provided to the clock input C of each register in the second register group 1028b.

The control logic circuit 1012 performs selective gating by gating a clock signal that is being provided to the clock inputs C of registers 1002 based on the toggling behavior of the registers 1002. More specifically, for each register 1002, the control logic circuit 1012 generates a corresponding gated clock signal 1026 that is suppressed for registers predicted to retain their state during a given clock cycle. The control logic circuit 1012 effectively groups the registers 1002 into the register groups 1028 by providing the same gated clock signal 1026 to all registers within a group. Registers in the same group receive identical clock control via shared gating logic, thereby enabling selective gating to be performed at the group level rather than individually. In this way, gating of the clock signal going to registers 1002 in a particular register group 1028 is performed together. For example, because the same gated clock signal, the first gated clock signal 1026a, goes to the clock input C of each register 1002 in the first register group 1028a, each register 1002 in the first register group 1028a is either gated or not gated depending on whether the first gated clock signal 1026a is gated.

FIG. 10D illustrates a timing diagram of signals shown in FIG. 10C. More specifically, FIG. 10D shows the clock signal 1010, the first gated clock signal 1026a, and the second gated clock signal 1026b from a time t0 to a time t3.

During the time from t0 to t1, no clock gating is performed for either the first register group 1028a or the second register group 1028b. Accordingly, from time t0 to time t1, the first gated clock signal 1026a and the second gated clock signal 1026b are both substantially the same as the clock signal 1010.

From time t1 to time t2, clock gating is performed for the first register group 1028a, but gating is not performed for the second register group 1028b. Accordingly, during the time from time t1 to time t2, the first gated clock signal 1026a is disconnected from the clock input C of each of the registers 1002 in the first register group 1028, providing no signal from time t1 to time t2. No signal is provided to the registers 1002 in the first register group 1028a during this time because it is predicted that no state information changes in any of the registers in first register group 1028a during the time period from time t1 to time t2. By providing no signal during that time, power consumption is reduced. Power consumption is reduced without reduced functionality, because the registers 1002 in the first register group 1026a do not need to receive a clock signal when the state information stored in the registers 1002 is not changing. The registers 1002 in the first register group 1028a are grouped together due to their common toggling behavior.

While clock gating is provided to the first register group 1028a from time t1 to time t2, no clock gating is provided to the second register group 1028b from time t2 to time t3. Accordingly, the second gated clock signal 1026b is substantially similar to the clock signal 1010 during the time period from time t1 to time t2.

During the time from t2 to t3, no clock gating is performed for either the first register group 1028a or the second register group 1028b. Accordingly, from time t2 to time t3, the first gated clock signal 1026a and the second gated clock signal 1026b are both substantially the same as the clock signal 1010.

As discussed above, the selective clock gating provided by the control logic 1012 achieves reduced power consumption by performing gating to clock signals being provided to registers 1002 for which the stored state information is predicted to remain unchanged. However, power consumption is not the sole criteria for determining the control logic 1012. One or more additional suitable metrics are also taken into account when determining the control logic 1012. In some embodiments, the suitable metrics also include circuit area, signal timing, functional correctness, or other suitable metrics.

Instead of a design engineer manually identifying the clock-gate enable logic for each module in the logic circuit 1012, which may be a very time-consuming process, instead, in some embodiments, the design of the control logic 1012 is determined automatically by one or more machine learning models executing on one or more devices, including the device 1022. In some embodiments, control logic 1012 is automatically inserted into the design 1000, resulting in the updated version of the design 1018 while keeping hard constraints on chip area and timing in the logic circuit.

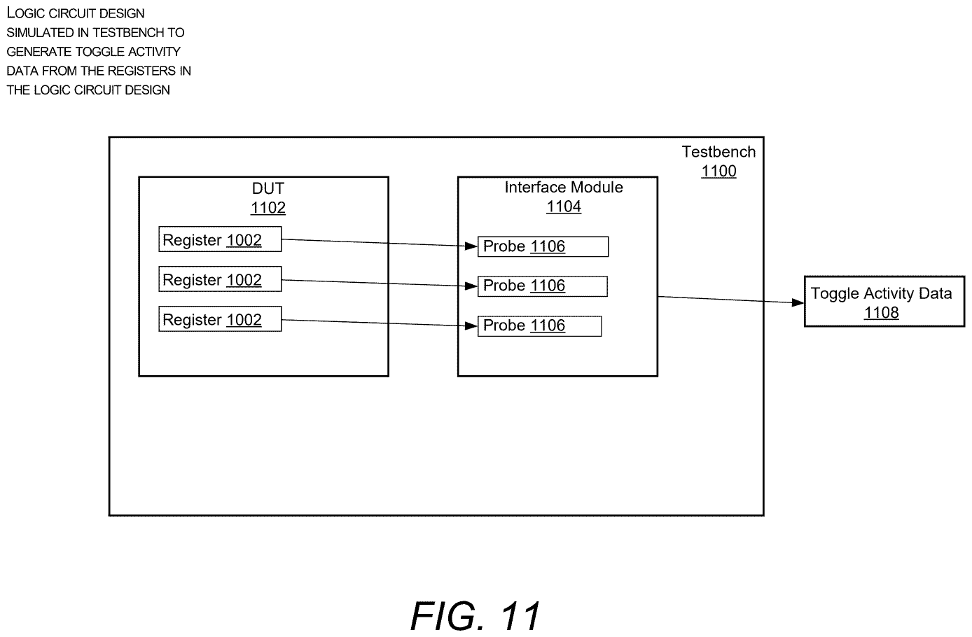

A simulation is performed on the logic circuit design 1018 to determine the toggle behavior of the storage circuits 1002 (e.g., the registers 1002) identified in the structural toggle specification. In some embodiments, this is accomplished by simulating the logic circuit design 1018 in a testbench (1100), as shown in FIG. 11. The testbench 1100 is a software-based simulation framework implemented in a hardware description language (HDL), such as SystemVerilog or VHDL, and includes stimulus generators, monitors, and checkers to emulate the functional environment of the logic circuit design 1018.

The testbench 1100 applies input stimuli to a design under test (DUT) (1102), which is a synthesizable representation of the logic circuit 1000 suitable for simulation and verification. The DUT 1102 is a simulation instantiation of the design 1018 that includes the same circuit elements described in the logic circuit design 1018, including the storage circuits 1002, combinational logic 1006, and clocking paths of the clock signal 1010. The testbench 1100 further includes an interface module (1104), which monitors the internal signals of the DUT 1102.

In some embodiments, the simulation setup begins with the generation of a structural toggle specification, which identifies relevant structural and behavioral elements, such as the subset of storage circuits 1002 whose activity is to be monitored. In some embodiments, the device 1022 parses the logic circuit design 1018 to output the structural toggle specification. For example, in some embodiments, a Python script is used to parse the HDL code in the logic circuit design 1018 and extract the structural toggle specification such that the structural toggle specification is a list of storage circuits—i.e., the registers 1002—whose toggle activity is to be monitored. The resulting structural toggle specification serves as a targeted list of registers that are instrumented for toggle tracking during simulation.

In some embodiments, the simulation is performed as part of a regression, which is an automated sequence of testbench simulations executed to verify functional correctness across a range of input scenarios. During the regression, toggle behavior of the storage circuits identified in the structural toggle specification is recorded. In some embodiments, the regression is part of a nightly regression. In some embodiments, the regression is conducted using the testbench environment 1100. The testbench 1100 provides input stimulus to the DUT 1102, which includes a simulation representation of the logic circuit design 1018, including the registers 1002 and their associated logic.

In some embodiments, the DUT 1102 is instantiated from a register-transfer level (RTL) design, which represents the logic circuit 1000 using a hardware description language (HDL) at a high level of abstraction that specifies data flow between registers. In other embodiments, the DUT 1102 is instantiated from a synthesized netlist, which is a lower-level representation generated by logic synthesis tools that map the RTL code to a specific set of logic gates. The choice between RTL, synthesized netlist, or other suitable format depends on the stage of the design and verification process, and both formats can be used to simulate the functional behavior of the logic circuit.

The testbench 1100 monitors the output responses of the DUT 1102 via the interface module 1104, which tracks the state of each register 1002 on each clock cycle of the clock signal 1010. In some embodiments, the interface module 1104 includes software-based instrumentation such as signal probes (1106), which detect whether each register 1002 changes state in response to the clock signal 1010. The toggle information is collected over the course of the simulation and is stored in a data structure referred to as toggle activity data (1108). In this way, the interface module 1104 determines the toggle activity data 1108 for storage circuits 1002.

In some embodiments, the toggle activity data 1108 includes log files that include register toggle information, the log files serving as the stored results of the regression during regression runs. The toggle activity data 1108 captures a time series of the state transitions (or lack thereof) for each storage circuit 1002. In this way, the interface module 1104 determines the toggle activity data 1108, where the toggle activity data 1108 indicates, for individual storage circuits 1002, whether the stored state information changes in response to a respective clock signal 1010. The toggle activity data 1108 serves as an input to downstream machine learning processes used to determine selective clock gating logic, as explained in greater detail below.

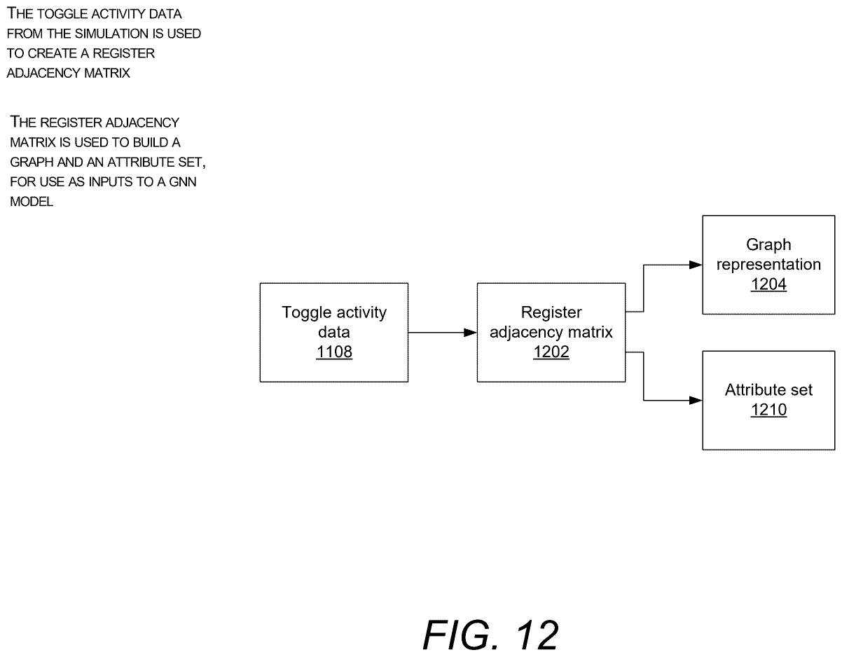

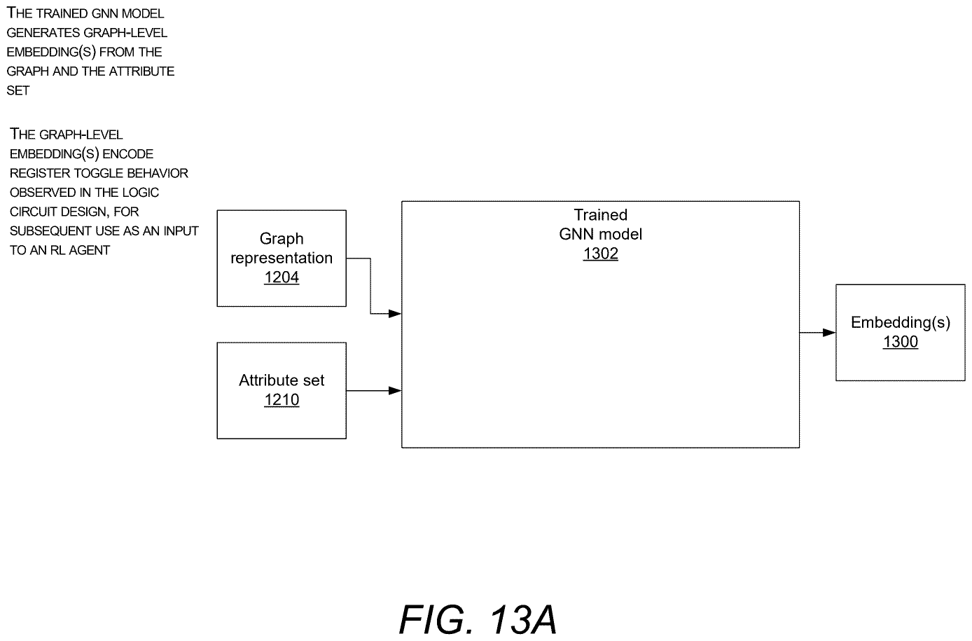

The toggle activity data 1108 is then analyzed to generate a register adjacency matrix (1202), which is shown in FIG. 12. The register adjacency matrix 1202 is a data structure that records statistical relationships between pairs of storage circuits 1002. In some embodiments, the matrix entry at row A and column B of the register adjacency matrix 1202 indicates how often register B changes state a defined number of clock cycles in the clock signal 1010 after a state change in register A. In some embodiments, the register adjacency matrix 1202 also stores metadata such as the maximum number of clock cycles of the clock signal 1010 observed between toggles of related registers, the probability of co-activation of registers across simulation cycles, or other suitable metadata.

The register adjacency matrix 1202 is then used to construct a graph representation (1204) by translating the register adjacency matrix 1202 into the graph representation 1204. The graph representation 1204 is interchangeably referred to herein as the graph 1204. The graph representation 1204 is a data structure that includes nodes and edges. The graph representation 1204 represents the toggle activity data 1108. Each node in the graph representation 1204 corresponds to a storage circuit such as one of the registers 1002 identified in the structural toggle specification.

Directed edges are formed in the graph 1204 between nodes based on the entries in the register adjacency matrix 1202. A directed edge is a connection between two nodes that has a defined direction, indicating a one-way relationship. An edge from node A to node B indicates that a change in the stored state information of the register associated with node A is statistically correlated with a subsequent change in the register associated with node B. For example, if there is a first register 1002a and a second register 1002b, and during regression runs the first register 1002a toggles followed by the second register 1002b, then the graph 1204 is constructed to include a directed edge from the first register 1002a to the second register 1002b. This directionality reflects relationships in toggle behavior and distinguishes directed edges from undirected edges, which represent bidirectional or symmetric relationships. In some embodiments, each directed edge also includes weight or timing metadata, such as the average or maximum number of clock cycles observed between the state transitions between connected registers.

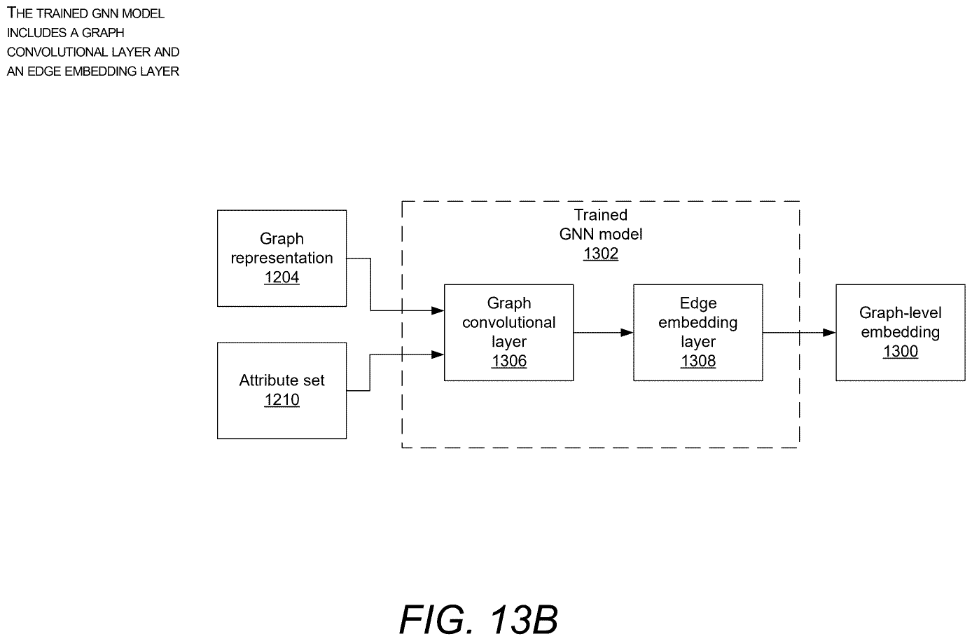

This metadata is captured in an associated attribute set 1210, which may be implemented, for example, as an edge attribute matrix or a parallel data structure accompanying the graph representation 1204. The attribute set 1210 may include node features (such as toggle frequency) and edge attributes (such as timing correlation). The graph representation 1204 and attribute set 1210 provide the input to a graph neural network (GNN), a machine learning model that will be discussed further with respect to FIG. 13A. Together, the graph representation 1204 and attribute set 1210 encode structural and behavioral toggle patterns, allowing machine learning techniques to model dependencies and support intelligent clock gating decisions.

In some embodiments, a trained graph neural network (GNN) model (1302) is applied to the graph representation 1204 and the attribute set 1210 to output one or more embedding(s) 1300, as shown in FIG. 13A. Each of the embedding(s) 1300 is a vector-based data representation that captures and characterizes high-level statistical, structural, and behavioral features and patterns of the logic circuit design 1018 and in the toggle activity data 1108. The embedding(s) 1300 are later used as input(s) to a reinforcement learning agent that determines clock-gating strategies. In some embodiments, the embedding(s) 1300 output by the GNN model 1302 consist of one graph-level embedding. In other embodiments, the embedding(s) 1300 output by the GNN model 1302 include multiple graph embeddings.

The GNN model 1302 is a software-implemented artificial neural network designed to operate on data structured as a graph. Like other neural networks, the GNN model 1302 includes multiple layers of interconnected units called neurons. Each neuron performs a weighted sum of its inputs, passes the result through a non-linear activation function, and outputs a value. The neurons are arranged in layers, with information flowing from input to output across the neural network. The neural network's parameters (i.e., the weights applied to input) are adjusted during a training process so that the model learns to map inputs to desired outputs. The structure of a traditional neural network assumes that the input data can be represented as a fixed-length vector or a two-dimensional array, such as a grid of pixel values in an image.

In contrast, a GNN is designed to operate on graph-structured data, where information is stored in nodes and edges. Each node may be associated with a feature vector (e.g., each node represents one of the registers 1002), and each edge may have associated attributes that define relationships between nodes (e.g., the relational connections between the registers). The trained GNN model 1302 is structured to accept input data in the form of a graph.

In some embodiments, as illustrated in FIG. 13B, the trained GNN model 1302 includes a graph convolutional layer (1306) that computes node embeddings by applying localized filters to the node features and their immediate neighbors. After the graph convolutional layer, the GNN model 1302 includes an edge embedding layer (1308) that computes pairwise features for edges in the register graph. These node and edge embeddings are combined and further processed to produce the embedding 1300, which is a graph-level embedding. This hierarchical processing enables the GNN model 1302 to capture both fine-grained and structural relationships in the toggle activity patterns of the logic circuit 1000.

To process the graph representation 1204, the GNN model 1302 performs a series of computations known as message passing. During message passing, each node updates its internal representation by aggregating information from its neighboring nodes and the edges connecting them. For example, the node corresponding to a particular register 1002 may receive messages from neighboring nodes representing registers that frequently toggle in a correlated manner. The GNN model 1302 combines this neighborhood information using learned weight matrices and non-linear functions, updating the feature vector of each node. This process is repeated over several layers, enabling each node to incorporate context about increasingly distant parts of the graph 1204.

After message passing, the node-level features are aggregated to produce the embedding 1300. In various embodiments, this aggregation may be a simple summation, an average, or a more complex operation such as attention-based pooling. The resulting embedding 1300 serves as a condensed representation of the toggle activity patterns present in the logic circuit design 1018. The embedding 1300 captures the interaction dynamics among the storage circuits 1002 as observed in the toggle activity data 1108 and encoded in the graph representation 1204.

As shown in FIGS. 13A and 13B, the GNN model 1302 receives the graph representation 1204 and attribute set 1210 as inputs, and the GNN model 1302 outputs the embedding 1300. The graph representation 1204 includes node-level features corresponding to individual storage circuits 1002 and edge-level features capturing their interaction patterns. The resulting graph embedding 1300, produced through the node and edge aggregation layers, serves as a compact yet expressive encoding of the register toggle behavior observed in the logic circuit design 1018 during the simulation.

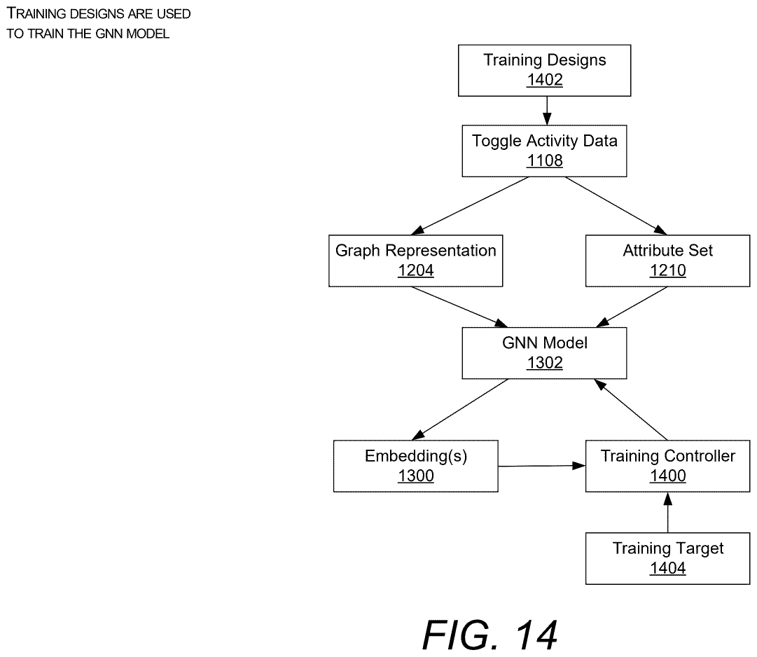

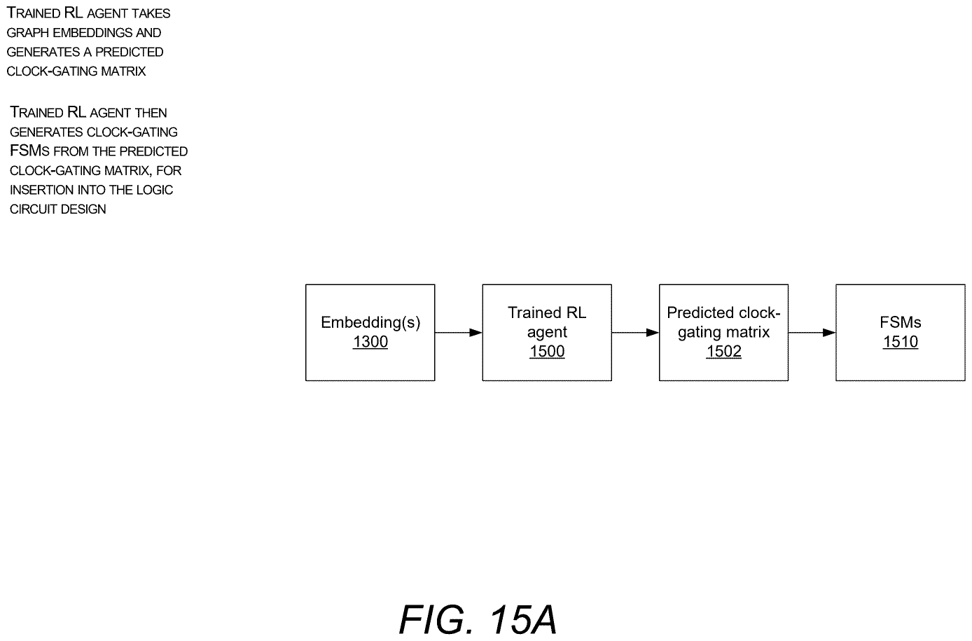

The GNN model 1302 may be executed by the circuit design processing system 1020 and trained in advance using multiple training designs (1402), as described in further detail with reference to FIG. 14. Once trained, the GNN model 1302 can generalize its understanding to new logic circuit designs, allowing the embedding 1300 to serve as a basis for subsequent optimization steps. FIGS. 13A and 13B show the use of the trained GNN model 1302 during inference, and FIG. 14 shows the training of the GNN model 1302. The term “inference” refers to the application of a previously trained machine learning model—such as the trained graph neural network (GNN) model 1302—to new data. During inference, the model parameters are fixed, and the model is used to generate outputs based on input data. In contrast, training refers to the process of adjusting the internal parameters of a model based on a dataset of known inputs and outputs, using optimization techniques to improve the model's accuracy or effectiveness. Training is typically performed once or periodically using a training dataset, whereas inference may be performed repeatedly during deployment, such as for new circuit designs in this context.

FIG. 14 illustrates a training process for the graph neural network (GNN) model (1302). Before the GNN model 1302 can be used to generate embeddings 1300 for a new logic circuit design, as shown in FIGS. 13A and 13B, the GNN model 1302 is first trained using the training designs 1402—which are previously analyzed logic circuit designs and their associated toggle activity data 1108. The training designs 1402 are distinct from the logic circuit design being optimized. Training on multiple such designs allows the GNN model 1302 to learn general structural and behavioral patterns that are useful for identifying storage circuits that are likely to retain their state across clock cycles. In this way, the GNN model 1302 can be applied effectively to new, previously unexamined logic circuit designs, which may be referred to as “unseen” circuit topologies.

For each training design 1402, a structural toggle specification is generated as previously described, and simulation is used to produce toggle activity data 1108. A corresponding register adjacency matrix is created from the toggle activity data 1108, and a graph representation 1204 is constructed using this matrix. As previously explained, the graph representation 1204 is a data structure comprising nodes and edges, where each node corresponds to a storage circuit and each edge represents a statistical relationship between observed state transitions (i.e., changes in the stored state information). In some embodiments, the graph representation 1204 also includes or accompanies an attribute set 1210, which provides additional information associated with each node and edge, such as toggle frequency or observed delay between toggles.

The graph representation 1204 and attribute set 1210 generated from the training design are supplied as input to the GNN model 1302, which produces the embedding 1300. During training, the toggle activity data 1108 from the training designs 1402 are used to build the register adjacency matrix from the training designs 1108. The register adjacency matrix in turn is used to build the graph representation 1204 and the attribute set 1210. The graph representation 1204 and the attribute set 1210 in turn are used to train the GNN model 1302. In this way, the register adjacency matrix is used to build the GNN model 1302.

The embedding 1300 is a learned representation that captures key features of the logic circuit design, including patterns relevant to power consumption and gating potential. During training, a training controller (1400) compares the embedding 1300 to a training target (1404), which may represent an idealized or known-effective feature vector. The training controller 1400 computes a loss value representing the difference between the embedding 1300 and the training target 1404 and uses backpropagation to update the parameters of the GNN model 1302.

This process is repeated across many iterations and over multiple training designs 1402 in the training dataset. The repeated updating of model parameters enables the GNN model 1302 to identify latent patterns across different designs in the training designs 1402 and to become increasingly effective at producing embeddings for unseen designs. Once training is complete, the GNN model 1302 is deployed in inference mode as described in FIGS. 13A and 13B. In some embodiments, the GNN model 1302 and training controller 1400 are implemented as software modules executing on the circuit design processing system 1020.

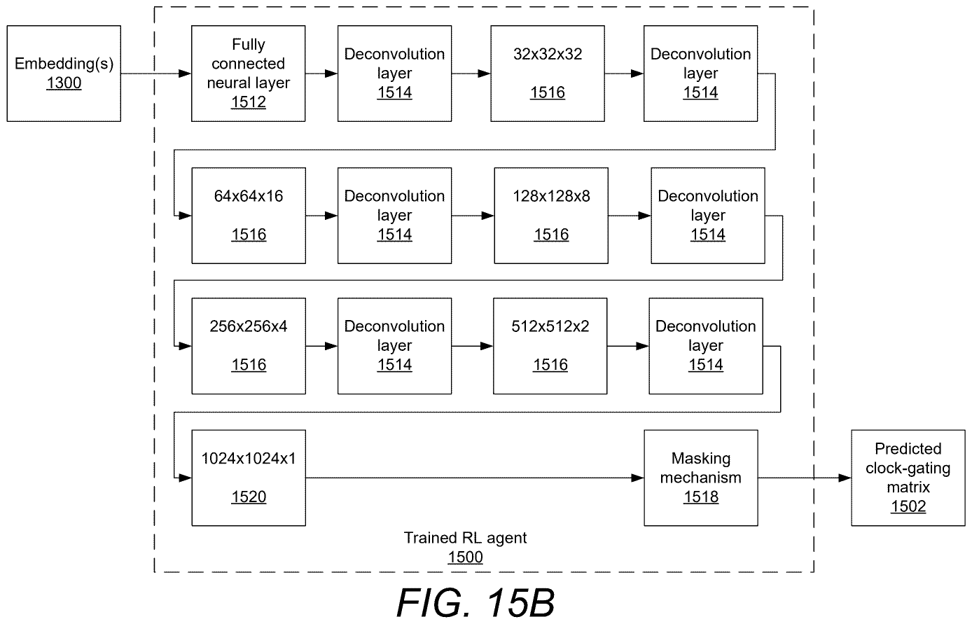

FIG. 15A illustrates the inference phase of a reinforcement learning (RL) agent (1500), which generates a predicted clock-gating matrix (1502) based on the embedding(s) (1300) generated by the trained GNN model (1302). The inference phase of the RL agent (1500) is an RL agent clock generation phase. In some embodiments, the embedding(s) 1300 are one or more graph embeddings that are used as inputs to the trained RL agent 1500. The RL agent 1500 executes on the circuit design processing system 1020. As discussed with respect to FIG. 13A, the embedding(s) 1300 include at least one graph embedding, created from the GNN 1302, that encodes structural and behavioral characteristics of the logic circuit design that are relevant to selective clock gating. The trained RL agent 1500 uses this embedding 1300 as an input to produce gating configurations aimed at reducing power consumption while preserving functional correctness.

The RL agent 1500 is a machine learning model that may be implemented as a software-based neural network trained using reinforcement learning techniques. Reinforcement learning is a category of machine learning in which an agent learns to make decisions by interacting with an environment and receiving feedback in the form of rewards or penalties. During training, over time, the RL agent 1500 adjusts its decision-making strategy, known as a policy, to maximize cumulative reward, refining its decision-making strategy over time. The RL agent 1500 is trained to be able to generate a predicted clock-gating matrix 1502 that optimizes for design objectives such as reduced power consumption, improved timing, and minimized area overhead. During inference, the trained RL agent 1500 receives the embedding 1300 as input and produces the predicted clock-gating matrix 1502 as output.

The predicted clock-gating matrix 1502 defines proposed gating relationships among storage circuits, such as the registers 1002. In some embodiments, each entry in the predicted clock-gating matrix 1502 indicates whether a pair or group of registers 1002 should be gated together, either as a binary decision or via a weighting that reflects a degree of affinity or predicted gating benefit. The predicted clock-gating matrix 1502 is the clock-gating matrix that is predicted as the best clock-gating matrix by the RL agent 1500. In some embodiments, the predicted clock-gating matrix 1502 is a fixed-size structure—such as a 1024×1024 array—regardless of the number of registers in the design. A masking mechanism is applied to disable unused rows and columns in the predicted clock-gating matrix 1502 when working with designs that contain fewer storage circuits. This fixed-size representation of the clock-gating matrix 1502 allows the RL agent 1500 to generalize across circuit designs of varying sizes and complexities.

For example, in some embodiments, using a fixed-size structure of a 1024×1024 array for the clock-gating matrix 1502 is sufficient to learn clock-gating mappings for any design up to 32 registers. For example, consider 3 registers, a, b and c. In this example, the clock gate matrix 1502 will have 9 outputs namely: {a, b, c, ab, ac, ba, bc, ca, cb}. If the design has less than 32 registers, a mask can be used to mask off corresponding portions on the 1024×1024 matrix.

After generating the predicted clock-gating matrix 1502, the RL agent 1500 uses the predicted clock-gating matrix 1502 to generate the FSMs 1510. The FSMs 1510 are clock-gating FSMs that generate a gate enable signal that is input to clock-gating modules instantiated inside the updated version (1016) of the design to enable clock gating. The FSMs 1510 are discussed in greater detail below with regard to FIG. 18.

In some embodiments, as illustrated in FIG. 15B, the RL agent 1500 includes a neural architecture that is configured to process the embedding 1300 by expanding the embedding 1300 through a series of neural layers, beginning with a fully connected neural layer (1512) that maps the embedding 1300 into a latent feature space. The output of the fully connected neural layer 1512 is passed through a sequence of deconvolution layers (1514). The output of each of the deconvolution layers 1514 is a structured output representation of relationships between the storage circuit 1002. Each of the deconvolution layers 1514 is a neural layer that progressively increases the spatial dimensionality of the representation. In some embodiments, as illustrated in FIG. 15B, the deconvolution layers 1514 expand the input through intermediate stages 1516 such as 32×32×32, 64×64×16, and so on, culminating in a final feature map (1520) of size 1024×1024×1. A mask mechanism (1518) applies a mask to the final feature map 1520 to provide the predicted clock-gating matrix 1502.

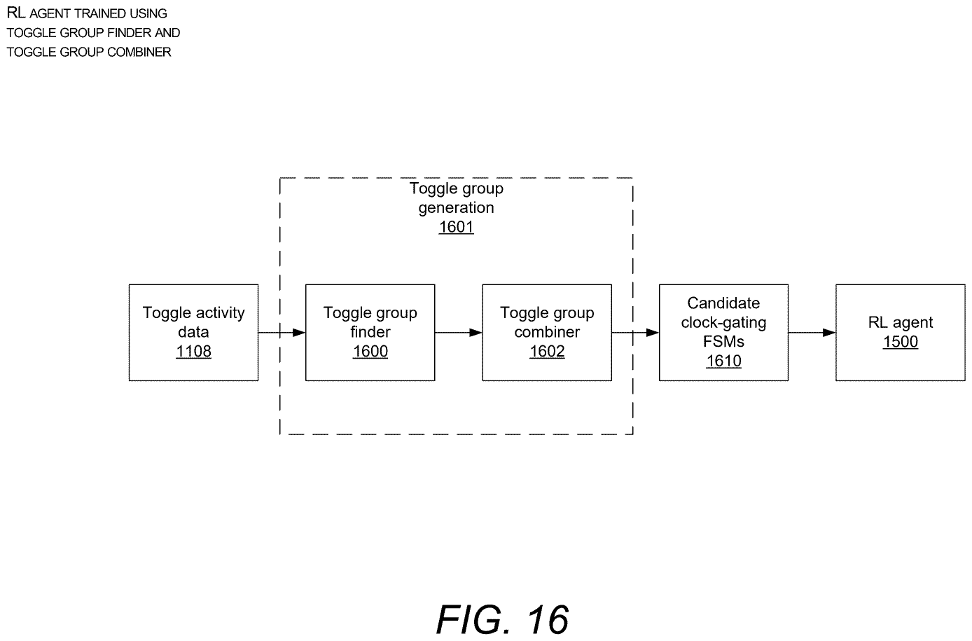

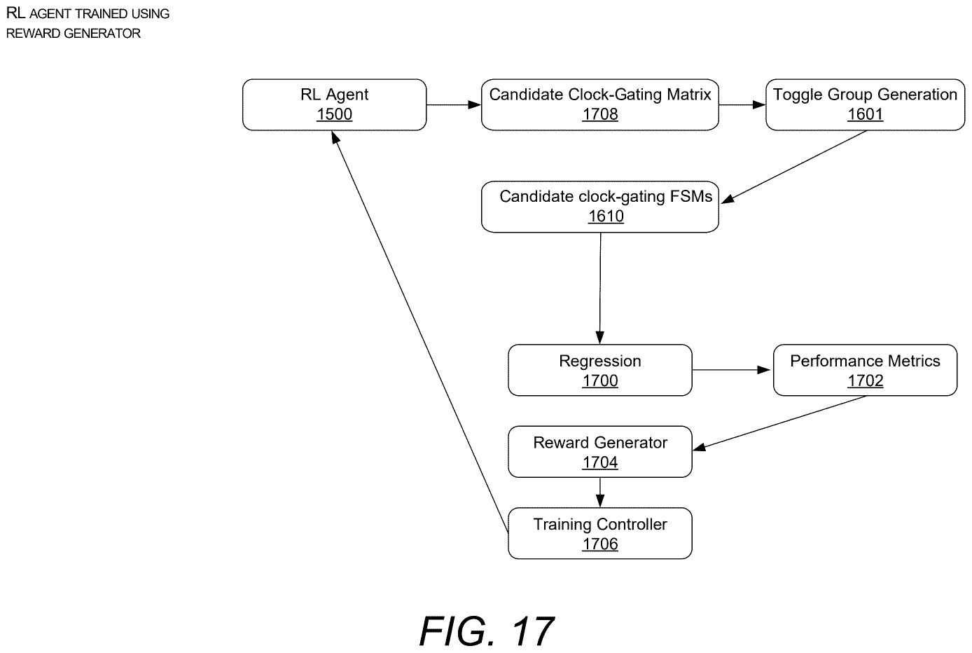

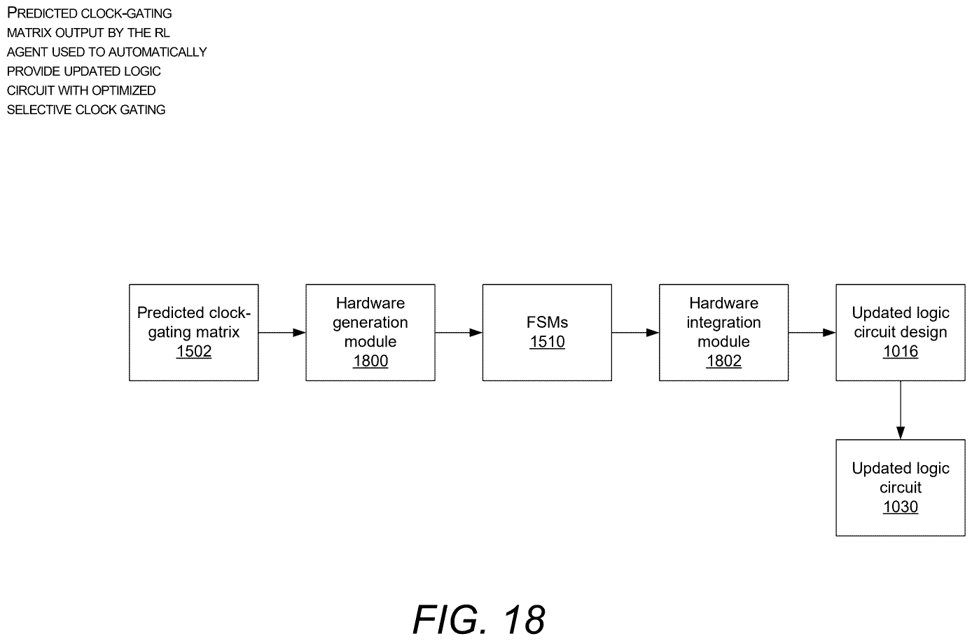

FIGS. 16 and 17 illustrate the RL agent training phase. FIG. 16 illustrates particular components involved in the training of the reinforcement learning (RL) agent (1500), specifically the process of toggle group generation (1601). The process of toggle group generation 1601 identifies groups of storage circuits (e.g., registers) that exhibit coordinated toggle behavior over time, which can be used to define effective clock-gating domains. In some embodiments, the RL agent 1500 is trained using a dataset of previously analyzed logic circuit designs. For each design in the training dataset, toggle activity data is collected and analyzed to identify coordinated register behavior. Toggle group generation 1601 is performed using a toggle group finder (1600) and a toggle group combiner (1602), and the resulting designs are evaluated to produce reward values based on metrics such as power, timing, and area. This training process is repeated across many iterations and over multiple logic circuit designs in the training dataset. Through this iterative process, the RL agent 1500 learns a policy for generating clock-gating control logic 1012 that balances multiple optimization goals and generalizes across different circuit topologies.

Two components of some embodiments of the toggle group generation process 1601 are the toggle group finder 1600 and the toggle group combiner 1602. The toggle group finder 1600 generates initial unique-register toggle groups based on the register toggle behavior (e.g., regression log results) observed during simulation of each design in the training dataset, as indicated in the toggle activity data 1108 obtained from each design in the training dataset. In some embodiments, the toggle group generation 1601 is performed independently for each design hierarchy—that is, for each module or submodule within the logic circuit design—such that toggle groups are identified within the scope of each local module rather than across the entire design in a flat or global manner. This modular approach aligns with hierarchical hardware design practices and allows for clock-gating logic to be inserted at appropriate structural levels of the design. For each such design, simulation is performed using the structural toggle specification, and the toggle activity data 1108 is collected to track register state changes over clock cycles.

The toggle group finder 1600 uses two data structures: an active register table (ART) and an active list table (ALT). The ART is used to monitor active register groups (ARGs), which are transient collections of storage circuits 1002 that toggle together during overlapping clock cycles. An ARG is initiated when any register in the design begins toggling. All registers that toggle in that same clock cycle are grouped into the initial ARG and stored as a valid entry in the ART. In some embodiments, each ART entry is labeled with a state indicator—such as “V” for valid or “C” for closed—to track its status as toggling progresses.

On subsequent clock cycles, the ART is updated to reflect the evolving composition of the ARG. If all registers in the current ARG appear in a valid ART entry, no update is made. If new toggling registers are observed, a new entry is added to the ART and marked as valid. If valid registers from a previous cycle are no longer active, they are removed from their corresponding entries. In the case of partial matches—where some, but not all, of a group's registers toggle—the non-toggling registers are pruned. If none of the registers in a valid group toggle in a given clock cycle, the corresponding entry is marked as closed. These updates ensure that each valid ART entry only reflects currently active and coherent register groups. Once the toggling behavior of an ARG ends (i.e., no monitored registers toggle in a given clock cycle) all ART entries are transitioned to the closed state.

Closed ART entries are then processed for insertion into the ALT. Before insertion, duplicate ART rows are removed, and multi-signal entries may be simplified to retain only the starting and ending toggling registers. Each unique result is appended to the ALT. The ART is then cleared in preparation for the next ARG. This process is repeated across all simulation cycles of the training design. At the conclusion of simulation, the ALT is deduplicated to produce a final active list representing the unique register toggle groups observed. These initial unique-register toggle groups serve as input to the toggle group combiner 1602, which attempts to refine and merge these register toggle groups to generate the final register toggle groups at each design hierarchy in order to define efficient clock-gating domains.

The toggle group combiner 1602 attempts to merge adjacent register toggle groups to discover larger combinations that still meet gating constraints. For instance, if two adjacent storage circuits—e.g., Reg1 and Reg2—are found to always toggle in sequence, the toggle group combiner 1602 may propose a merged register toggle group {Reg1, Reg2}. The feasibility of merging is assessed based on whether the toggling patterns are sufficiently correlated to allow for a common clock-gating domain. The combiner continues this process iteratively, evaluating increasingly larger combinations while avoiding cases in which toggling occurs independently. The process continues until all possible combinations of register groups are evaluated.

In some embodiments, the final output of the toggle group generation process 1601 is a collection of proposed register toggle groups, each of which may correspond to a candidate clock-gating FSM (1610). The toggle group generation process 1601 can be used to infer all possible clock-gating FSMs for the design. The candidate clock-gating FSMs 1610 define clock enable signals based on the toggling behavior of the grouped storage circuits and are incorporated into clock-gated versions of the logic circuit. These clock-gated circuit versions are subsequently used in the RL training flow, as discussed with respect to FIG. 17.

FIG. 17 illustrates the reward generation process used in training the reinforcement learning (RL) agent (1500). As part of the training, the RL agent 1500 is tasked with generating a candidate clock-gating matrix 1708 for each training design. The term “candidate clock-gating matrix 1708” is used to refer to a clock-gating matrix used during training (as opposed to “predicted clock-gating matrix 1502,” which is the term used to refer to a clock-gating matrix during inference). The candidate clock-gating matrix 1708 is interpreted by the process of toggle group generation 1601 to identify storage circuits that should be grouped under common clock-gating domains. From these groupings, candidate clock-gating FSMs 1610 are instantiated and incorporated into a modified version of the circuit design.

To evaluate the effectiveness of the candidate clock-gating matrix 1708, the modified circuit design—including the candidate clock-gating FSMs 1610—is subjected to a regression process (1700). In some embodiments, the regression 1700 is a nightly regression that includes running a suite of functional tests as well as collecting synthesis, power, and timing reports from standard EDA tools. These evaluations are performed on both the original (non-gated) and the clock-gated versions of the design. The clock-gated version of the design is the modified version of the design with the clock-gating FSMs determined from the toggle group generation process 1601 incorporated into the design.

The output of the regression 1700 is a set of performance metrics (1702) for both the clock-gated and non-clock-gated designs. In some embodiments, the metrics include (a) functional correctness based on test results, (b) power consumption, (c) critical timing paths, and (d) circuit area usage. In other embodiments, a subset of these metrics may be used, and other suitable metrics may also be used. A reward generator (1704) calculates a reward value based on the differences between these metrics. In some embodiments, the reward is calculated using a weighted sum such as:

$$Reward = α ( Reg\_clk - gated - Reg\_non - clk - gated ) + β ( Power\_non - clk - gated - Power\_clk - gated ) + γ ( Timing\_non - clk - gated - Timing\_clk - gated ) + δ ( Area\_clk - gated - Area\_non - clk - gated ) ,$$

where α, β, γ, and δ are tunable weighting coefficients.

The resulting reward is provided to a training controller (1706), which compares the received reward to expected or historical values and adjusts the parameters of the RL agent 1500 accordingly. In some embodiments, the adjustment is performed using policy gradient methods (e.g., Proximal Policy Optimization (PPO)) or other reinforcement learning optimization techniques. By iteratively applying this process across multiple training designs, the RL agent 1500 learns to propose increasingly effective clock gating-matrices that improve power efficiency while preserving functionality and design constraints. As a result of this training, the RL agent 1500 learns the policy that is applied during the inference phase. In some embodiments, once the RL agent 1500 has been trained on some 5-10 designs, the RL agent 1500 can be used to predict the clock-gate matrix for new unseen designs.

FIG. 18 illustrates a process of using the predicted clock-gating matrix 1502 to provide the updated logic circuit 1030. More specifically, the predicted clock-gating matrix 1502 is used to instantiate and integrate control logic 1012, such as the FSMs 1510, into the original circuit design 1018 to provide the updated version (1016) of the logic circuit design. The FSMs 1510 are clock-gating FSMs that are an embodiment of the control logic 1012 of FIG. 10B. The predicted clock-gating matrix 1502 defines how storage circuits, such as the registers 1002 identified in the structural toggle specification, are grouped for the purposes of selective clock control. Each group of registers defined in the predicted clock-gating matrix 1502 corresponds to a clock-gating domain that is controlled by a respective FSM 1510.

These FSMs 1510 are generated by the RL agent 1500 based on the toggling behavior observed in the training and inference phases and are configured to enable or disable the delivery of the clock signal 1010 to their corresponding register groups. A hardware generation module (1800) instantiates these FSMs 1510 into synthesizable hardware description language (HDL) constructs based on the FSM definitions output by the RL agent 1500. The FSMs 1510 are inserted into the circuit design at appropriate clock distribution points to selectively gate the clock signal(s) 1010 before reaching the registers 1002 within the clock-gated domains. A hardware integration module (1802) modifies the HDL representation 1018 of the logic circuit 1000 by connecting each FSM 1510 to the clock enable line of its respective register group. The resulting modification yields the updated version (1016) of the logic circuit design in which the FSMs 1510 implement the selective clock gating logic derived through reinforcement learning. The FSMs 1510 in the updated version 1016 of the logic circuit design selective gates the clock signal(s) for which the stored state information is predicted, based on the embedding 1300, to remain unchanged. The FSMs 1510 are optimized for suitable metrics. In some embodiments, the suitable metrics include power consumption, circuit area, signal timing, and functional correctness, with trade-offs determined based on the tunable weighted coefficients used in the reward generator 1704 of FIG. 17 that was used to train the RL agent 1500.

In some embodiments, the updated version (1016) of the logic circuit design is subjected to a post-integration verification process to ensure that all original functionality is preserved and that the FSMs 1510 correctly gate clock signals based on the intended control logic. Once verified, the updated version (1016) of the logic circuit design may be synthesized, placed, and routed using standard electronic design automation tools to create the updated logic circuit (1030), which incorporates clock gating determined, during the design, by machine learning. The resulting updated logic circuit 1030 exhibits reduced power consumption due to the suppression of unnecessary clock transitions, which may reduce heat generation and extend battery life in power-constrained systems. Because the FSMs 1510 are instantiated based on machine-learned behavioral patterns specific to the target design, the clock gating implementation can optimize trade-offs across power savings, timing closure, and area utilization—offering improved performance and accuracy over traditional heuristic-based gating strategies while maintaining functional correctness.

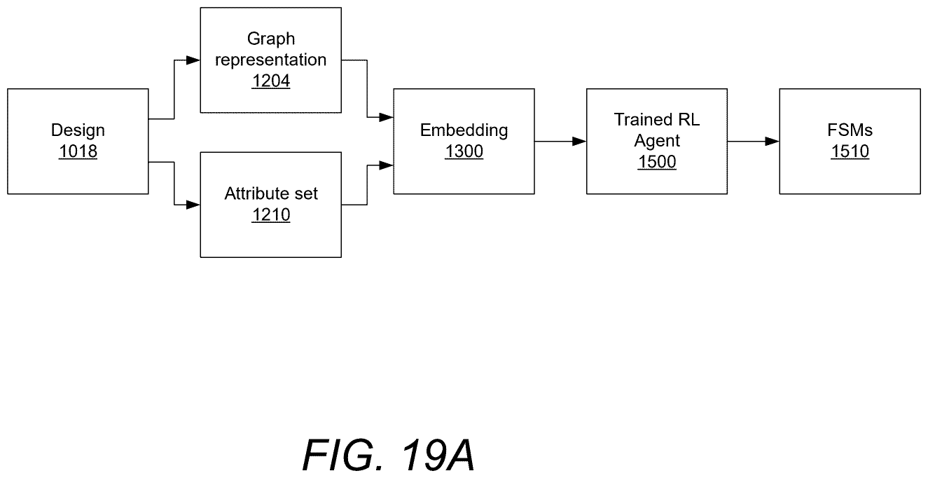

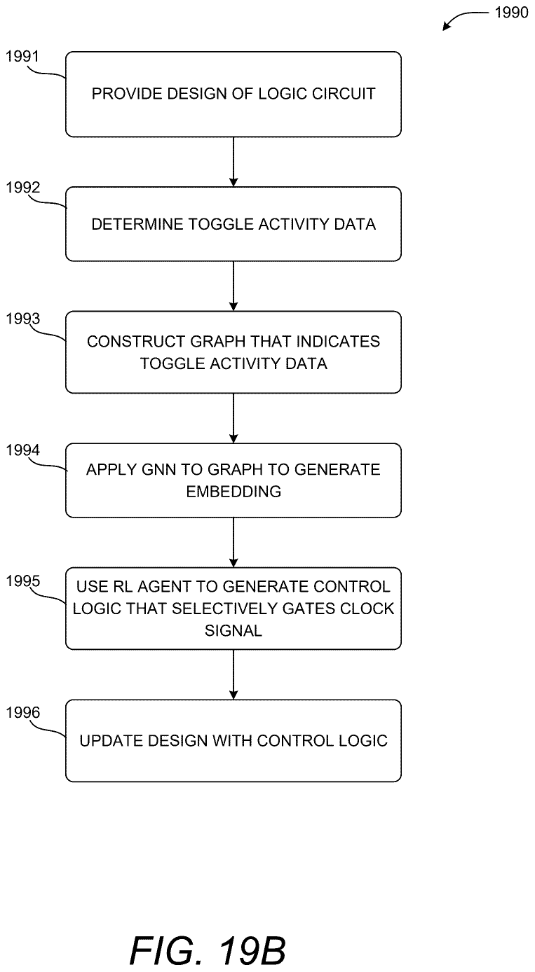

FIG. 19A illustrates a high-level overview of a selective clock gating flow for generating the FSMs 1510 based on toggle behavior in the logic circuit design 1018. As shown, the logic circuit design 1018 is used to generate the graph representation 1204 and the attribute set 1210, as described in detail above with reference to FIGS. 11 and 12. The graph representation 1204 captures statistical relationships among storage circuits (e.g., registers 1002) based on toggle activity, and the attribute set 1210 includes additional metadata associated with nodes and edges in the graph 1204.

The graph representation 1204 and the attribute set 1210 are provided as inputs to the trained graph neural network (GNN) model, which generates the embedding 1300. As described with reference to FIG. 13A, the embedding 1300 is a vector-based representation that encodes statistical and structural patterns observed in the toggle activity data 1108. The embedding 1300 captures behaviorally significant information about the logic circuit 1018 relevant to power-efficient clock gating.

The embedding 1300 is then supplied to the trained reinforcement learning (RL) agent 1500, which applies a trained policy to determine clock-gating control logic. The RL agent 1500 outputs one or more gating configurations in the form of the FSMs 1510, which selectively enable or disable clock signals to groups of registers based on their predicted state retention behavior. As previously described with reference to FIGS. 15 through 18, the FSMs 1510 are instantiated using a hardware generation module and integrated into the design to produce an updated logic circuit 1030 optimized for reduced power consumption, timing integrity, and functional correctness.

Turning now to FIG. 19B, the following section describes aspects of a routine 1990 for implementing aspects of the disclosed techniques. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, or the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, or the like.

Thus, it should be appreciated that, in some embodiments, the logical operations described herein are implemented (1) as a sequence of computer-implemented acts or program modules running on a computing system and/or (2) as interconnected machine logic circuits or circuit modules or other circuit components within the system. Accordingly, the logical operations described herein are referred to variously as states, operations, structural devices, acts, or modules. These operations, structural devices, acts, and modules may be implemented in software, in firmware, in special purpose digital logic, in other circuit components, or any combination thereof.

For example, the operations of the routine are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following illustration refers to the components depicted in the present application, it can be appreciated that the operations of the routine may be also implemented in many other ways. For example, the routine may be implemented, at least in part, by a processor or circuit of another remote computer (which can be a server) or a local processor or circuit of a local computer (which can be a client device receiving a message or a client device sending the message). Any aspect of the routine, which can include the generation of a prompt, communication of any of the messages with the prompt to an Natural Language Processing (NLP) algorithm, use of an NLP algorithm, or a display of a result generated by an NLP algorithm, can be performed on either a device sending a message, a device receiving a message, or on a server managing communication of the messages for a thread. In addition, one or more of the operations of the routine may alternatively or additionally be implemented, at least in part, by a chipset working alone or in conjunction with other software modules. Any service, circuit or application suitable for providing input data indicating the state of any device may be used in operations described herein.

The routine 1990 starts at operation 1991. In some embodiments, the routine 1990 is a method for reducing power consumption in a logic circuit. At operation 1991, a design of the logic circuit is provided. The logic circuit includes a plurality of storage circuits configured to store state information and to receive one or more clock signals. The routine then proceeds to operation 1992. At operation 1992, toggle activity data indicating, for individual storage circuits of the plurality of storage circuits, whether the stored state information changes in response to a respective clock signal is determined.

The routine then proceeds to operation 1993. At operation 1993, a graph that represents the toggle activity data is constructed. The graph includes nodes and edges. The nodes corresponding to the plurality of storage circuits. The edges represent statistical relationships among the determined changes in the stored state information. The routine then proceeds to operation 1994. At operation 1994, a graph neural network to the graph is applied. The application includes generating an embedding that characterizes patterns in the toggle activity data.

The routine then proceeds to operation 1995. At operation 1995, via a reinforcement learning agent executing on a circuit design processing system, control logic that selectively gates the one or more clock signals provided to storage circuits for which the stored state information is predicted, based on the embedding, to remain unchanged is determined. application includes generating an embedding that characterizes patterns in the toggle activity data. The routine then proceeds to operation 1996. At operation 1996, an updated version of the design that includes the determined control logic is generated.

Although the examples described herein refer to the use of a large language model or a machine learning model, the techniques disclosed herein can utilize any combination of suitable Natural Language Processing (NLP) algorithms that analyze and model interactions between devices and human language. This can include, but is not limited to, any suitable combination of algorithms such as Tokenization algorithms that divide a text into individual words or tokens; Part-of-Speech (POS) Tagging algorithms that assign grammatical labels (e.g., noun, verb, adjective) to each word in a sentence, helping to analyze sentence structure; Named Entity Recognition (NER) algorithms that identify and classify named entities, such as names of people, places, organizations, and more within a text; Sentiment Analysis algorithms that determine the sentiment or emotional tone of a piece of text, and classifying it as positive, negative, or neutral; Text Classification algorithms that categorize text documents into predefined classes or categories, such as topic classification and sentiment analysis; Machine Translation algorithms, like neural machine translation (NMT), automatically translate text from one language to another; Language Modeling algorithms, including n-grams and neural language models, an also to referred to herein as a large language model (LLM) or a “language model,” are used to predict the probability of a word or sequence of words given the context of the preceding words; Named Entity Disambiguation algorithms which help disambiguate the meaning of named entities by linking them to specific entities in a knowledge base or resolving them to their appropriate entities; Text Summarization algorithms that generate concise summaries of longer texts, which can be extractive (selecting and combining sentences) or abstractive (generating new sentences); Speech Recognition algorithms, since the system may process speech messages and not just text messages; Information Extraction algorithms that identify structured information from unstructured text, for extracting events or facts from articles or message attachments; Coreference Resolution algorithms that determine which words or phrases in a text refer to the same entity, e.g., identifying that “he” and “John” refer to the same person in a sentence; Question Answering algorithms that answer questions posed in natural language by extracting relevant information from text corpora or knowledge bases; Word Embeddings algorithms that represent words as dense, continuous-valued vectors, which capture semantic relationships between words; Text Generation algorithms that use Recurrent Neural Networks (RNNs) and Transformers to create human-like text, including chatbots, content generation, and creative writing, Dependency Parsing algorithms that analyze the grammatical structure of sentences by identifying the relationships between words, including subjects, objects, and modifiers; Topic Modeling algorithms, such as Latent Dirichlet Allocation (LDA), to uncover the underlying topics in a collection of documents; and Language Generation algorithms that create coherent and contextually relevant language, such as generating human-like responses in a conversational AI system. In some embodiments, the system can also utilize audio-to-audio models, where audio files or audio streams are communicated to the model with a prompt for causing the models to generate the responses described herein.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as GPT, BLOOM, PaLM, Mistral, Gemini, and/or LLaMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise. Note also that generative image models can generate videos, and the term “image” also encompasses two-dimensional and three-dimensional video.

In some cases, a generative model can be multi-modal. For instance, a model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include certain GPT variants such as GPT-4o, Gemini, Chameleon, etc. Multi-modal models can also include lightweight models such as Phi-3-Vision-128K-Instruct.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc. The term “vision language model” refers to any multi-modal generative model that can generate text describing images or videos, including CLIP, BLIP, Vision-and-Language BERT, Flamingo, Chameleon, etc.

The term “prompt,” as used herein, refers to input provided to a generative model that the generative model uses to generate outputs. A prompt can be provided in various modalities, such as text, an image, audio, video, etc. The term “language generation prompt” refers to a prompt to a generative model where the requested output is in the form of natural language. The term “image generation prompt” refers to a prompt to a generative model where the requested output is in the form of an image.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

The disclosed techniques can utilize any type of AI Agent, agent, or large language model. For example, based on the architecture there can be at least four types of LLM that are based on the technical structure of the model: Transformer-based models: modern LLMs use this (e.g., GPT, BERT, LLaMA), Autoregressive models (e.g., GPT): Predict the next word in a sequence, Autoencoding models (e.g., BERT): Understand and fill in blanks in a sentence, and Sequence-to-sequence models (e.g., T5): Convert one text sequence to another (e.g., translate English to French). In other examples, based on the purpose or use there can be at least three types of LLMs: General-purpose models: Like GPT-4, Claude, Gemini-trained broadly for many tasks, Domain-specific models: Trained for specialized fields like medicine (e.g., BioGPT), law, finance, or coding (e.g., CodeLlama, Codex), and Instruction-tuned models: Fine-tuned to follow human instructions better (e.g., ChatGPT, Alpaca, Mistral-Instruct).

An LLM can also include a Specialized Language Model (SLM) that is specifically trained to perform a set of functions. For example, a first SLM can be trained to determine issues with a code base, a second SLM can be trained to identify users, etc. Each SLM can be pre-trained with input data and instructions for causing each SLM to relate and identify specific sets of objects and data sets. The LLM or the SLM can be part of a server executing aspects of the present disclosure or the LLM or the SLM can be part of a separate computer in communication with the server.

The terms “AI model,” “AI Agent,” or “LLM” as used herein are intended to encompass not only individual models but also composite systems comprising multiple models. Accordingly, in some embodiments, the techniques disclosed herein may be implemented by or in connection with an AI model or AI model system. The AI model system may include, without limitation, a single model, a multimodal system, a system of models, a chain of models, or other configurations in which multiple models operate in cooperation.

The term “model” may further encompass sub-models, model systems, and mixtures of experts. For example, the model system may include specialized models delegated to perform subtasks, and these subtasks may be orchestrated by a controller or master model to achieve a complex computational result. In some embodiments, the AI system may include reasoning models, models utilizing chain-of-thought prompting techniques, or models designed for delegated task execution. Such configurations may include, but are not limited to, convolutional neural networks (CNNs), deep neural networks (DNNs), transformer-based models, or other machine learning architectures.

These models may be operable to receive one or more input types (e.g., text, image, audio), perform a set of inferential or generative operations based on the input(s), and generate output data that corresponds to predictions, classifications, recommendations, textual responses, or control instructions. The model(s) may be further configured for interoperability with user interfaces, application programming interfaces (APIs), or other software systems to support a variety of functionalities.

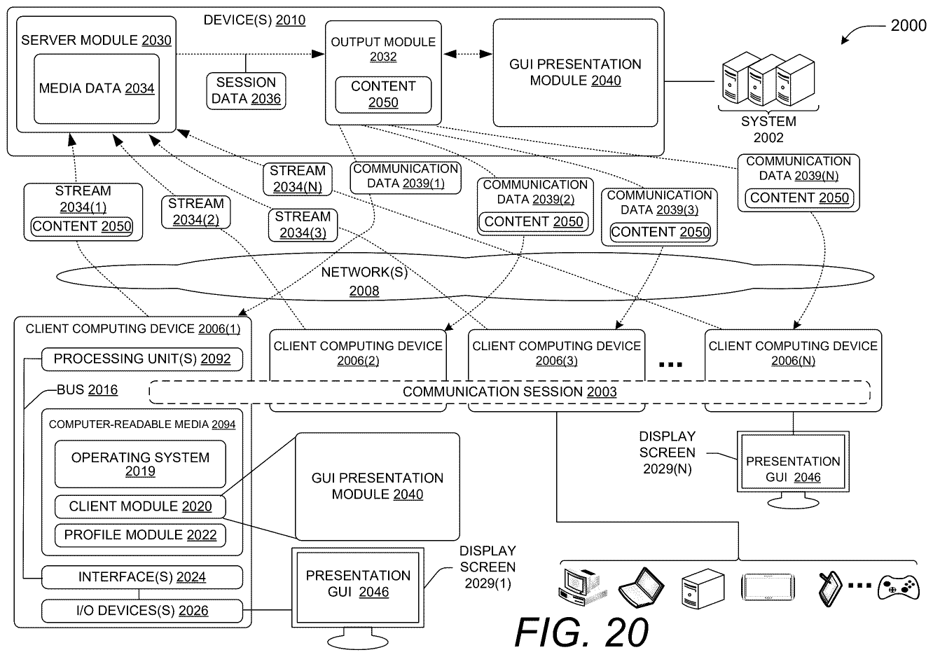

Turning now to FIG. 20, a diagram illustrating an example environment 2000 in which a system 2002 can implement the disclosed techniques is shown. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, a system 2002 may function to collect, analyze, and share data that is displayed to users of a communication session 2003. As illustrated, the communication session 2003 may be implemented between a number of client computing devices 2006(1) through 2006(N) (where N is a number having a value of two or greater) that are associated with or are part of the system 2002. The client computing devices 2006(1) through 2006(N) enable users, also referred to as individuals, to participate in the communication session 2003. A communication session 2003 can include a call, which can be a direct call from a person to others, a communication session 2003 can also include a meeting, which is an appointment that is established by a calendar event defining attendees.

In this example, the communication session 2003 is hosted, over one or more network(s) 2008, by the system 2002. That is, the system 2002 can provide a service that enables users of the client computing devices 2006(1) through 2006(N) to participate in the communication session 2003 (e.g., via a live viewing and/or a recorded viewing). Consequently, a “participant” to the communication session 2003 can comprise a user and/or a client computing device (e.g., multiple users may be in a room participating in a communication session via the use of a single client computing device), each of which can communicate with other participants. As an alternative, the communication session 2003 can be hosted by one of the client computing devices 2006(1) through 2006(N) utilizing peer-to-peer technologies. The system 2002 can also host chat conversations and other team collaboration functionality (e.g., as part of an application suite).

In some implementations, such chat conversations and other team collaboration functionality are considered external communication sessions distinct from the communication session 2003. A computing system 2002 that collects participant data in the communication session 2003 may be able to link to such external communication sessions. Therefore, the system may receive information, such as date, time, session particulars, and the like, that enables connectivity to such external communication sessions. In one example, a chat conversation can be conducted in accordance with the communication session 2003. Additionally, the system 2002 may host the communication session 2003, which includes at least a plurality of participants co-located at a meeting location, such as a meeting room or auditorium, or located in disparate locations.

In examples described herein, client computing devices 2006(1) through 2006(N) participating in the communication session 2003 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds can be communicated with the messages.

The system 2002 of FIG. 20 includes device(s) 2010. The device(s) 2010 and/or other components of the system 2002 can include distributed computing resources that communicate with one another and/or with the client computing devices 2006(1) through 2006(N) via the one or more network(s) 2008. In some examples, the system 2002 may be an independent system that is tasked with managing aspects of one or more communication sessions such as communication session 2003. As an example, the system 2002 may be managed by entities such as SLACK, WEBEX, GOTOMEETING, GOOGLE HANGOUTS, etc.

Network(s) 2008 may include, for example, public networks such as the Internet, private networks such as an institutional and/or personal intranet, or some combination of private and public networks. Network(s) 2008 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 2008 may utilize communications protocols, including packet-based and/or datagram-based protocols such as Internet protocol (“IP”), transmission control protocol (“TCP”), user datagram protocol (“UDP”), or other types of protocols. Moreover, network(s) 2008 may also include a number of devices that facilitate network communications and/or form a hardware basis for the networks, such as switches, routers, gateways, access points, firewalls, base stations, repeaters, backbone devices, and the like.

In some examples, network(s) 2008 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 2010 may include one or more computing devices that operate in a cluster or other grouped configuration to share resources, balance load, increase performance, provide fail-over support or redundancy, or for other purposes. For instance, device(s) 2010 may belong to a variety of classes of devices such as traditional server-type devices, desktop computer-type devices, and/or mobile-type devices. Thus, although illustrated as a single type of device or a server-type device, device(s) 2010 may include a diverse variety of device types and are not limited to a particular type of device. Device(s) 2010 may represent, but are not limited to, server computers, desktop computers, web-server computers, personal computers, mobile computers, laptop computers, tablet computers, or any other sort of computing device.

A client computing device (e.g., one of client computing device(s) 2006(1) through 2006(N)) (each of which are also referred to herein as a “data processing system”) may belong to a variety of classes of devices, which may be the same as, or different from, device(s) 2010, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 2006(1) through 2006(N) of the various classes and device types can represent any type of computing device having one or more data processing unit(s) 2092 operably connected to computer-readable media 2094 such as via a bus 2016, which in some instances can include one or more of a system bus, a data bus, an address bus, a PCI bus, a Mini-PCI bus, and any variety of local, peripheral, and/or independent buses. Executable instructions stored on computer-readable media 2094 may include, for example, an operating system 2019, a client module 2020, a profile module 2022, and other modules, programs, or applications that are loadable and executable by data processing units(s) 2092.

Client computing device(s) 2006(1) through 2006(N) may also include one or more interface(s) 2024 to enable communications between client computing device(s) 2006(1) through 2006(N) and other networked devices, such as device(s) 2010, over network(s) 2008. Such network interface(s) 2024 may include one or more network interface controllers (NICs) or other types of transceiver devices to send and receive communications and/or data over a network. Moreover, client computing device(s) 2006(1) through 2006(N) can include input/output (“I/O”) interfaces (devices) 2026 that enable communications with input/output devices such as user input devices including peripheral input devices (e.g., a game controller, a keyboard, a mouse, a pen, a vocal input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 20 illustrates that client computing device 2006(1) is in some way connected to a display device (e.g., a display screen 2029(N)), which can display a UI according to the techniques described herein.

In the example environment 2000 of FIG. 20, client computing devices 2006(1) through 2006(N) may use their respective client modules 2020 to connect with one another and/or other external device(s) in order to participate in the communication session 2003, or in order to contribute activity to a collaboration environment. For instance, a first user may utilize a client computing device 2006(1) to communicate with a second user of another client computing device 2006(2). When executing client modules 2020, the users may share data, which may cause the client computing device 2006(1) to connect to the system 2002 and/or the other client computing devices 2006(2) through 2006(N) over the network(s) 2008.

The client computing device(s) 2006(1) through 2006(N) may use their respective profile modules 2022 to generate participant profiles (not shown in FIG. 20) and provide the participant profiles to other client computing devices and/or to the device(s) 2010 of the system 2002. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 20, the device(s) 2010 of the system 2002 include a server module 2030 and an output module 2032. In this example, the server module 2030 is configured to receive, from individual client computing devices such as client computing devices 2006(1) through 2006(N), media streams 2034(1) through 2034(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 2030 is configured to receive a collection of various media streams 2034(1) through 2034(N) during a live viewing of the communication session 2003 (the collection being referred to herein as “media data 2034”). In some scenarios, not all of the client computing devices that participate in the communication session 2003 provide a media stream. For example, a client computing device may only be a consuming, or a “listening”, device such that it only receives content associated with the communication session 2003 but does not provide any content to the communication session 2003.

In various examples, the server module 2030 can select aspects of the media streams 2034 that are to be shared with individual ones of the participating client computing devices 2006(1) through 2006(N). Consequently, the server module 2030 may be configured to generate session data 2036 based on the streams 2034 and/or pass the session data 2036 to the output module 2032. Then, the output module 2032 may communicate communication data 2039 to the client computing devices (e.g., client computing devices 2006(1) through 2006(3) participating in a live viewing of the communication session). The communication data 2039 may include video, audio, and/or other content data, provided by the output module 2032 based on content 2050 associated with the output module 2032 and based on received session data 2036. The content 2050 can include the streams 2034 or other shared data, such as an image file, a spreadsheet file, a slide deck, a document, etc. The streams 2034 can include a video component depicting images captured by an I/O device 2026 on each client computer. The content 2050 also include input data from each user, which can be used to control a direction and location of a representation. The content can also include instructions for sharing data and identifiers for recipients of the shared data. Thus, the content 2050 is also referred to herein as input data 2050 or an input 2050.

As shown, the output module 2032 transmits communication data 2039(1) to client computing device 2006(1), and transmits communication data 2039(2) to client computing device 2006(2), and transmits communication data 2039(3) to client computing device 2006(3), etc. The communication data 2039 transmitted to the client computing devices can be the same or can be different (e.g., positioning of streams of content within a user interface may vary from one device to the next).

In various implementations, the device(s) 2010 and/or the client module 2020 can include GUI presentation module 2040. The GUI presentation module 2040 may be configured to analyze communication data 2039 that is for delivery to one or more of the client computing devices 2006. Specifically, the UI presentation module 2040, at the device(s) 2010 and/or the client computing device 2006, may analyze communication data 2039 to determine an appropriate manner for displaying video, image, and/or content on the display screen 2029 of an associated client computing device 2006. In some implementations, the GUI presentation module 2040 may provide video, image, and/or content to a presentation GUI 2046 rendered on the display screen 2029 of the associated client computing device 2006. The presentation GUI 2046 may be caused to be rendered on the display screen 2029 by the GUI presentation module 2040. The presentation GUI 2046 may include the video, image, and/or content analyzed by the GUI presentation module 2040.

In some implementations, the presentation GUI 2046 may include a plurality of sections or grids that may render or comprise video, image, and/or content for display on the display screen 2029. For example, a first section of the presentation GUI 2046 may include a video feed of a presenter or individual, a second section of the presentation GUI 2046 may include a video feed of an individual consuming meeting information provided by the presenter or individual. The GUI presentation module 2040 may populate the first and second sections of the presentation GUI 2046 in a manner that properly imitates an environment experience that the presenter and the individual may be sharing.

In some implementations, the GUI presentation module 2040 may enlarge or provide a zoomed view of the individual represented by the video feed in order to highlight a reaction, such as a facial feature, the individual had to the presenter. In some implementations, the presentation GUI 2046 may include a video feed of a plurality of participants associated with a meeting, such as a general communication session. In other implementations, the presentation GUI 2046 may be associated with a channel, such as a chat channel, enterprise Teams channel, or the like. Therefore, the presentation GUI 2046 may be associated with an external communication session that is different from the general communication session.

Clause A: A method for reducing power consumption in a logic circuit (1000), the method comprising: providing a design (1018) of the logic circuit (1000), the logic circuit (1000) comprising a plurality of storage circuits (1002) configured to store state information and to receive one or more clock signals (1010); determining toggle activity data (1108) indicating, for individual storage circuits (1002) of the plurality of storage circuits (1002), whether the stored state information changes in response to a respective clock signal (1010); constructing a graph (1204) that represents the toggle activity data (1108), the graph (1204) comprising nodes and edges, the nodes corresponding to the plurality of storage circuits (1002), and the edges representing statistical relationships among the determined changes in the stored state information; applying a graph neural network (1302) to the graph (1204), the application comprising generating an embedding (1300) that characterizes patterns in the toggle activity data (1108); via a reinforcement learning (RL) agent (1500) executing on a circuit design processing system (1020), determining control logic (1012) that selectively gates the one or more clock signals (1010) provided to storage circuits (1002) for which the stored state information is predicted, based on the embedding (1300), to remain unchanged; and generating an updated version (1016) of the design that comprises the determined control logic (1012).

Clause B: The method of Clause A, wherein the control logic (1012) is further determined based on at least one additional metric, and wherein the at least one additional metric includes at least one of circuit area, signal timing, or functional correctness.

Clause C: The method of Clause A or Clause B, further comprising manufacturing an updated version (1030) of the logic circuit based on the updated version (1016) of the logic circuit design.

Clause D: The method of any of Clauses A-C, wherein determining the toggle activity data (1108) comprises simulating the design (1000) in a testbench (1100) that applies input stimuli and monitors output responses for a design under test (1102) comprising an instantiation of the design (1000).

Clause E: The method of any of Clauses A-D, wherein constructing the graph (1204) comprises generating a register adjacency matrix (1202) based on the toggle activity data (1108) and translating the register adjacency matrix (1202) into the graph (1204).

Clause F: The method of any of Clauses A-E, wherein the embedding (1300) is a vector representation that captures statistical and structural patterns associated with the toggle activity of the storage circuits (1002).

Clause G: The method of any of Clauses A-F, further comprising training the RL agent (1500), training the RL agent (1500) comprising: generating a plurality of candidate clock-gating matrices (1708), wherein each of the candidate clock-gating matrices (1708) has a fixed-size structure; performing a plurality of regressions (1700) to evaluate the candidate clock-gating matrices (1708); and updating parameters of the RL agent (1500) based on the evaluations to train the RL agent (1500) to generate the control logic (1012).

Clause H: The method of any of Clauses A-G, further comprising training the RL agent (1500) using a toggle group finder process (1600), a toggle group combiner process (1602), and a reward generation process (1704).

Clause I: The method of any of Clauses A-H, wherein the RL agent (1500) includes a neural architecture configured to process the embedding (1300) by applying a plurality of neural layers that expand the embedding into a higher-dimensional representation, the plurality of layers comprising at least one deconvolution layer (1514) that increases a spatial dimensionality of the embedding (1300) to produce a structured output representation of relationships between storage circuits (1002) of the plurality of storage circuits (1002).

Clause J: The method of any of Clauses A-I, wherein the RL agent (1500) applies at least one policy trained using rewards generated from at least one of regression results, power consumption data, signal timing data, or circuit area data.

Clause K: The method of Clause J, wherein the rewards are computed as a weighted sum of differences between clock-gated and non-clock-gated versions of the logic circuit (1010).

Clause L: The method of any of Clauses A-K, wherein the control logic (1012) comprises a clock-gating finite state machine (FSM) (1510) configured to enable or disable the delivery of the clock signals (1010) based on register group activity.

Clause M: The method of Clause L, wherein the updated version (1016) of the logic circuit design comprises the FSMs (1510) integrated via a hardware integration module (1802) that modifies a hardware description language (HDL) representation of the design.

Clause N: A system for reducing power consumption in a logic circuit (1010), the system comprising: at least one memory (932) having processor-executable code stored therein; and at least one processor (902) that is adapted to execute the processor-executable code, wherein the processor-executable code includes processor-executable instructions that, in response to execution, enable the system to perform actions comprising any of Clauses A-M.

Clause O: The system of Clause N, wherein the control logic (1012) is further determined based on at least one additional metric, and wherein the at least one additional metric includes at least one of circuit area, signal timing, or functional correctness.

Clause P: The system of Clause N or Clause O, the actions further comprising training the RL agent (1500) using a toggle group finder process (1600), a toggle group combiner process (1602), and a reward generation process (1704).

Clause Q: The system of any of Clauses N-P, wherein the control logic (1012) comprises a finite state machine (FSM) (1510) configured to enable or disable the delivery of the clock signals (1010) based on register group activity.

Clause R: A processor-readable storage medium (932) for reducing power consumption in a logic circuit (1010), having stored thereon processor-executable code that, upon execution by at least one processor (902), enables actions comprising any of Clauses A-M.

Clause S: The processor-readable storage medium of Clause R, wherein the control logic (1012) is further determined based on at least one additional metric, and wherein the at least one additional metric includes at least one of circuit area, signal timing, or functional correctness.

Clause T: The processor-readable storage medium of Clause R or Clause S, the actions further comprising training the RL agent (1500) using a toggle group finder process (1600), a toggle group combiner process (1602), and a reward generation process (1704).

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The meanings identified below do not necessarily limit the terms but merely provide illustrative examples for the terms. For example, each of the terms “based on” and “based upon” is not exclusive, and is equivalent to the term “based, at least in part, on,” and includes the option of being based on additional factors, some of which may not be described herein. As another example, the term “via” is not exclusive, and is equivalent to the term “via, at least in part,” and includes the option of being via additional factors, some of which may not be described herein. Use of particular textual numeric designators does not imply the existence of lesser-valued numerical designators. The term “or” is an inclusive “or” operator unless specifically indicated otherwise. For example, the phrase “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof. The meaning of “in” includes “in” and “on.”

The embodiments disclosed herein may be provided as a computer program product or software that may include a machine-readable medium (or a computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes a machine-readable storage medium (e.g., ROM, random access memory (“RAM”), a magnetic disk storage medium, an optical storage medium, flash memory devices, etc.), and the like.

Unless specifically stated otherwise and as apparent from the previous discussion, it is appreciated that throughout the description, discussions utilizing terms such as “processing,” “computing,” “determining,” “displaying,” or the like refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from and write information to the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips that may be referenced throughout the above description may be represented by voltages, currents, electromagnetic waves, magnetic fields, optical fields, or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations, and variations of the disclosed embodiments incorporating the spirit and substance of the invention may occur to persons skilled in the art, the invention should be construed to include everything within the scope of the appended claims and their equivalents.

What is claimed is:

1. A method for reducing power consumption in a logic circuit, the method comprising:
providing a design of the logic circuit, the logic circuit comprising a plurality of storage circuits configured to store state information and to receive one or more clock signals;
determining toggle activity data indicating, for individual storage circuits of the plurality of storage circuits, whether the stored state information changes in response to a respective clock signal;
constructing a graph that represents the toggle activity data, the graph comprising nodes and edges, the nodes corresponding to the plurality of storage circuits, and the edges representing statistical relationships among the determined changes in the stored state information;
applying a graph neural network to the graph, the application comprising generating an embedding that characterizes patterns in the toggle activity data;
via a reinforcement learning (RL) agent executing on a circuit design processing system, determining control logic that selectively gates the one or more clock signals provided to storage circuits for which the stored state information is predicted, based on the embedding, to remain unchanged; and
generating an updated version of the design that comprises the determined control logic.

2. The method of claim 1, wherein the control logic is further determined based on at least one additional metric, and wherein the at least one additional metric includes at least one of circuit area, signal timing, or functional correctness.

3. The method of claim 1, further comprising manufacturing an updated version of the logic circuit based on the updated version of the logic circuit design.

4. The method of claim 1, wherein determining the toggle activity data comprises simulating the design in a testbench that applies input stimuli and monitors output responses for a design under test comprising an instantiation of the design.

5. The method of claim 1, wherein constructing the graph comprises generating a register adjacency matrix based on the toggle activity data and translating the register adjacency matrix into the graph.

6. The method of claim 1, wherein the embedding is a vector representation that captures statistical and structural patterns associated with the toggle activity of the storage circuits.

7. The method of claim 1, further comprising training the RL agent, training the RL agent comprising:
generating a plurality of candidate clock-gating matrices, wherein each of the candidate clock-gating matrices has a fixed-size structure;
performing a plurality of regressions to evaluate the candidate clock-gating matrices; and
updating parameters of the RL agent based on the evaluations to train the RL agent to generate the control logic.

8. The method of claim 1, further comprising training the RL agent using a toggle group finder process, a toggle group combiner process, and a reward generation process.

9. The method of claim 1, wherein the RL agent includes a neural architecture configured to process the embedding by applying a plurality of neural layers that expand the embedding into a higher-dimensional representation, the plurality of layers comprising at least one deconvolution layer that increases a spatial dimensionality of the embedding to produce a structured output representation of relationships between storage circuits of the plurality of storage circuits.

10. The method of claim 1, wherein the RL agent applies at least one policy trained using rewards generated from at least one of regression results, power consumption data, signal timing data, or circuit area data.

11. The method of claim 10, wherein the rewards are computed as a weighted sum of differences between clock-gated and non-clock-gated versions of the logic circuit.

12. The method of claim 1, wherein the control logic comprises a clock-gating finite state machine (FSM) configured to enable or disable the delivery of the clock signals based on register group activity.

13. The method of claim 12, wherein the updated version of the logic circuit design comprises the FSMs integrated via a hardware integration module that modifies a hardware description language (HDL) representation of the design.

14. A system for reducing power consumption in a logic circuit, the system comprising:
at least one memory having processor-executable code stored therein; and
at least one processor that is adapted to execute the processor-executable code, wherein the processor-executable code includes processor-executable instructions that, in response to execution, enable the system to perform actions, comprising:
providing a design of the logic circuit, the logic circuit comprising a plurality of storage circuits configured to store state information and to receive one or more clock signals;
determining toggle activity data indicating, for individual storage circuits of the plurality of storage circuits, whether the stored state information changes in response to a respective clock signal;
constructing a graph that represents the toggle activity data, the graph comprising nodes and edges, the nodes corresponding to the plurality of storage circuits, and the edges representing statistical relationships among the determined changes in the stored state information;
applying a graph neural network to the graph, the application comprising generating an embedding that characterizes patterns in the toggle activity data;
via a reinforcement learning (RL) agent executing on a circuit design processing system, determining control logic that selectively gates the one or more clock signals provided to storage circuits for which the stored state information is predicted, based on the embedding, to remain unchanged; and
generating an updated version of the design that comprises the determined control logic.

15. The system of claim 14, wherein the control logic is further determined based on at least one additional metric, and wherein the at least one additional metric includes at least one of circuit area, signal timing, or functional correctness.

16. The system of claim 14, the actions further comprising training the RL agent using a toggle group finder process, a toggle group combiner process, and a reward generation process.

17. The system of claim 14, wherein the control logic comprises a finite state machine (FSM) configured to enable or disable the delivery of the clock signals based on register group activity.

18. A processor-readable storage medium for reducing power consumption in a logic circuit, having stored thereon processor-executable code that, upon execution by at least one processor, enables actions, comprising:
receiving a graph that represents toggle activity data, the graph comprising nodes and edges, the nodes corresponding to a plurality of storage circuits in the logic circuit, the edges representing statistical relationships among the determined changes in stored state information in the plurality of storage circuits, the toggle activity data indicating, for individual storage circuits of the plurality of storage circuits, whether the stored state information changes in response to a respective clock signal;
applying a graph neural network to the graph, the application comprising generating an embedding that characterizes patterns in the toggle activity data;
via a reinforcement learning agent executing on a circuit design processing system, determining control logic that selectively gates the one or more clock signals provided to storage circuits for which the stored state information is predicted, based on the embedding, to remain unchanged; and
generating an updated version of a design of the logic circuit such that the updated version comprises the determined control logic.

19. The processor-readable storage medium of claim 18, wherein the control logic is further determined based on at least one additional metric, and wherein the at least one additional metric includes at least one of circuit area, signal timing, or functional correctness.

20. The processor-readable storage medium of claim 18, the actions further comprising training the RL agent using a toggle group finder process, a toggle group combiner process, and a reward generation process.
